(19) United States
(12) Patent Application Publication
(10) Pub. No.: US 2026/0245762 A1
(43) Pub. Date: Aug. 20, 2026

(54) SYSTEMS AND METHODS FOR GENERATION OF PB-212

(71) Applicant: Curadel Surgical Innovations, Inc., Bonita Springs, FL (US)

(72) Inventor: John V. Frangioni, Bonita Springs, FL (US)

(73) Assignee: Curadel Surgical Innovations, Inc., Bonita Springs, FL (US)

(21) Appl. No.: 19/542,002

(22) Filed: Feb. 17, 2026

Related U.S. Application Data
(60) Provisional application No. 63/760,427, filed on Feb. 19, 2025.
(60) Provisional application No. 63/766,824, filed on Mar. 4, 2025.

(51) Int. Cl. G21G 1/00; G21G 1/04

(52) U.S. Cl. CPC G21G 1/001; G21G 1/04

(57) ABSTRACT

In accordance with at least one aspect of this disclosure, there is provided a system for the continuous production of Pb-212, comprising a first flow path and a second flow path. The first flow path is a closed loop fluid circuit for continuously generating Pb-212 from decay of a parent isotope. In the fluid circuit of the first flow path is a collection column that encourages decay of the parent or intermediate isotope into Pb-212 and collects the Pb-212 for harvesting. The first flow path can be a primary Pb-212 purification flow path. The second flow path is an open flow path for circulating a plurality of fluids through the collection column to elute the column and harvesting the Pb-212 for later use, for example in the production of radiotherapeutics. The second flow path can be a secondary Pb-212 flow path.

### CROSS-REFERENCE TO RELATED APPLICATIONS

This application claims priority to and the benefit of U.S. Provisional Patent Application Nos. 63/760,427 filed Feb. 19, 2025, and 63/766,824 filed Mar. 4, 2025, the entire contents of each application is herein incorporated by reference in its entirety.

### TECHNICAL FIELD

The present disclosure relates to systems and methods for generating Pb-212 and more particularly to generating ultra-pure Pb-212.

### BACKGROUND

Lead-212 (Pb-212) is an important radionucleotide for use in certain radiotherapeutics for treatment of cancer. Therefore, means for generation of Pb-212, particularly high purity (ultra-pure) Pb-212, are desired in the art.

Conventional production means utilize Thorium-228 (Th-228) decay as a source for generating the Pb-212. Th-228 decay is first solid Radium-224 (Ra-224), then gaseous Radon-220 (Rn-220; thoron gas). Many conventional techniques attempt to extract Pb-212 by milking a Ra-224 generator using acidic eluants. However, these methods result in low specific activity (i.e., stable Pb and multiple impurities) Pb-212.

Many other techniques harvest gaseous Rn-220 for generation of Pb-212. For example, Li et al. (DOI: https://doi.org/10.2967/jnumed. 122.264009), describes techniques for harvesting Rn-220 use a small swab of glass (quartz) wool to which Th-228 has been adsorbed. The glass wool is adhered to the bottom of a bottle cap and the bottle is flipped upside down. As the Rn-220 gas emanates from the Th-228 and decays it gets stuck to the glass walls of the bottle in the form of Pb-212. Though it is known Rn-220 is 7.5-times heavier than air, the conventional techniques for harvesting Pb-212 utilize passive (Brownian) motion to hope that the Rn-220 diffuses away from the Th-228 and ends up on the side of the vessel. If the Rn-220 does end up in the vessel as desired, the glass vessel must then be washed with a small volume of mild acid to solubilize the Pb-212, but this is difficult because the surface area of the collection bottle is large.

Another technique, such as described in U.S. Pat. No. 11,348,702 to O'hara utilizes a carrier gas to force gaseous Rn-220 from an emanation source through a column packed with a sorbent, such as urea powder, or a column having a coiled stainless steel tube to capture the Pb-212. O'hara also discloses embodiments that utilized a vacuum source downstream of the column to pull the emanation gas through the column. However, O'hara does not disclose maintaining a closed loop system for the continuous circulation of fluid through the emanation source, in combination with an open circuit elution flow path.

While the conventional techniques have been considered satisfactory for their intended purpose, there is an ever-present need for improved systems and methods for generating large-scale, ultra-pure Pb-212 from a Th-228 source, in a closed system, and without a carrier gas. This disclosure provides a solution for this need.

### SUMMARY

In accordance with at least one aspect of this disclosure, there is provided a system for the continuous production of Pb-212, comprising a first flow path and a second flow path. The first flow path is a closed loop fluid circuit for continuously generating Pb-212 from decay of a parent isotope. In the fluid circuit of the first flow path is a collection column that encourages decay of the parent or intermediate isotope into Pb-212 and collects the Pb-212 for harvesting. The first flow path can be a primary Pb-212 purification flow path. The second flow path is an open flow path for circulating a plurality of fluids through the collection column to elute the column and harvesting the Pb-212 for later use, for example in the production of radiotherapeutics. The second flow path can be a secondary Pb-212 flow path such that the Pb-212 that is ultimately accumulated from the system is pure or ultra-pure, suitable for the use in the production of radiotherapeutics. The system includes various components disposed in each of the first and second flow paths, each component will be described further herein.

In the first flow path, there is a radiation source, or a parent isotope supported on or in a solid support (e.g., Th-228 or Ra-224) configured to decay into gaseous Rn-220, The source and solid support can be included in a housing, referred to herein as a seed cartridge. The seed cartridge includes an inlet and an outlet within the housing, where the support is between the inlet and the outlet. The solid support can be or include titanium or a titanium compound. In certain embodiments, the seed cartridge can be oriented in the first flow path such that the flow from the inlet to the outlet of the seed cartridge flows in a direction parallel relative to gravity (e.g., wherein the inlet is on a top of the housing, and the outlet is on the bottom of the housing).

In certain embodiments, the seed cartridge housing can include a first coupler and a second coupler configured to connect the housing to the flow path. In certain embodiments, the first coupler can extend axially from a proximal face of the housing, and the second coupler can extend axially from a distal face of the housing. A second seed cartridge having the same housing can be included in the flow path fluidically connected to the first seed cartridge in series.

A collection column configured to collect the gaseous Rn-220 released from the seed cartridge source is disposed in the first flow path downstream of the source. The collection column is packed with a medium configured to adsorb Pb-212 generated from decay of Rn-220 within the collection column. The medium within the collection column can include metal beads (e.g., titanium), for example configured to induce turbulence into the gas flowing through the collection column to encourage and ensure decay into Pb-212. Inducing turbulence in the collection column can increase collision rate of the Rn-220 particles with the beads thereby increasing adsorption to the surface of the beads, and can increase residence time within the column maximizing Pb-212 adsorption. Similarly, a sintered titanium foam can be used as a collection material based on its high surface area and turbulent flow. In certain embodiments, a cooling element can be in thermal communication with the collection column to cool gas flowing therethrough to a temperature of, at most, below a boiling point of the gaseous Rn-220 to prevent passage of the Rn-220 from the outlet of the collection column. In certain embodiments, the cooling element can be or include a cryocooler or a dewar cooler or the like.

A pump configured to pump air through the first flow path to push the Rn-220 from the source to the collection column is disposed in the first flow path between an outlet of the collection column and the inlet of the seed cartridge. In certain embodiments, the pump can be or include a peristaltic pump. In certain embodiments one or more moisture traps (e.g., dehumidifying filters, desiccants, or the like) can be disposed in the first flow path upstream and/or downstream of the pump configured to reduce or eliminate moisture within the first flow path to prevent washout of the source in the seed cartridge. In certain embodiments one or more monitoring devices can be included in the first flow path, such as pressure sensors, temperature sensors, radiation PIN detectors, and/or gamma spectrometers to monitor the pressure, temperature, and radioactivity in the first flow path and to monitor the composition of gas within the collection column.

In the second flow path, one or more inflow valves are disposed upstream of the inlet of the collection column configured to flow one or more fluids through the collection column to elute the collection column and thereby collect the Pb-212 in a downstream component (e.g., a production hot cell). The collection column is disposed in the second flow path since the second flow path is provided to elute the Pb-212 from the column and to further clean and reset the column once harvesting is complete. Also disposed in the second flow path are one or more outflow valves downstream of the collection column configured to pass the collected Pb-212 to the downstream component such as the production hot cell.

A switching valve is disposed in both the first flow path and the second flow path configured to selectively switch between a first mode of operation in which the first flow path is utilized and a second mode of operation in which the second flow path is utilized. The switching valve is positioned and configured so as to prevent simultaneous use of the first flow path and second flow path.

In certain embodiments, the one or more inflow valves disposed in the second flow path includes a multi-position fluid selector inflow valve configured to sequentially pass a respective fluid of a plurality of fluids from a respective fluid source to the collection column based on a position of the multi-position fluid selector inflow valve. A plurality of fluid sources can be connected to the multi-position fluid selector valve, wherein each position (or port) of the valve is associated with a respective fluid. In certain embodiments, the multi-position fluid selector inflow valve can be a six-position selector valve and the fluids can include water, EtOH, nitrogen, nitric acid, and NaAc, where one position on the valve is plugged or is an “off” position.

In certain embodiments, a second switching valve is disposed in the second flow path downstream of the multi-position fluid selector inflow valve and upstream of the first switching valve. The second switching valve is configured to selectively pass the respective fluid from the muti-position fluid selector inflow valve to the collection column or bypass the collection column based on the position of the second switching valve. The second switching valve can be a two-position switching valve, switching between the first position where fluid passes to the collection column and to the first switching valve, and a second position where fluid bypasses the collection column.

In certain embodiments, the one or more outflow valves disposed in the second flow path include a first multi-position outflow valve downstream of the second switching valve configured to pass one or more fluids of the plurality of fluids from the collection column to a first downstream component, a second downstream component, or to bypass the second downstream component based on a position of the first multi-position outflow valve. The first multi-position outflow valve can be a two-position selector valve configured to pass one or more of the plurality of fluids from the collection column or the respective fluid source based on the position of the six-position fluid selector inflow valve, based on the position of the second switching valve, and based on the position of the first multi-position outflow valve. In the first position, the first multi-position outflow valve is configured to pass the one or more fluids from the second switching valve directly to the second multi-position outflow valve or to the second downstream component. In the second position, the first multi-position outflow valve is configured to pass the one or more fluids from the second switching valve to the first downstream component.

A second multi-position outflow valve configured to pass one or more fluids of the plurality of fluids from the first muti-position outflow valve to a third downstream component or a fourth downstream component based on the position of the second multi-position outflow valve. The second multi-position outflow valve is a four-position selector valve configured to pass one or more of the plurality of fluids from the first multi-position outflow valve based on the position of the six-position fluid selector inflow valve, based on the position of the second switching valve, based on the position of the first multi-position outflow valve, and based on the position of the second multi-position outflow valve. In the first position, the second multi-position outflow valve is configured to pass the one or more fluids from the second switching valve or the second downstream component to the third downstream component. In the second position, the second multi-position outflow valve is configured to pass the one or more fluids from the second switching valve or the second downstream component to the fourth downstream component in a second position. In the third position, the second multi-position outflow valve is configured to pass the one or more fluids from the second switching valve or the second downstream component to the second downstream component. The fourth position of the second multi-position outflow valve can be plugged, or an “off” position.

In certain embodiments, the first downstream component can be a waste collector, the second downstream component can be a Pb-212 secondary purification column, the third downstream component can be a Pb-212 production cell, and the fourth downstream component can be a dead end pressure channel for pressure testing the second flow path.

In certain embodiments, the seed cartridge can be housed within a seed module housing. The first flow path and at least a portion of the second flow path can be fully contained within the seed module housing. In certain embodiments, the seed module housing can include a first portion and a second portion, and the seed cartridge can be included in the first housing portion and the collection column and at least a portion of the first and second flow paths can be housed within the second housing portion. A plurality of seed modules can be configured to be contained within a field housing, and each seed module can be individually fluidically connected to the second flow path. In certain embodiments, both of the seed module housing and the field housing can include lead shielding properties (e.g., the housing can be or include lead, tungsten, or include other shielding properties), where the field housing can be a Pb-212 purification hot cell.

In certain embodiments, the field housing defines an interior vault space surrounded by lead shielding components. Within the interior vault space, a rotary table and a frame can be included to support the seed modules, where the plurality of seed modules can be mounted to the rotary table within the interior space of the field housing. In certain embodiments, the multi-position fluid selector inflow valve is operatively connected to be supported outside of the interior vault space. In certain embodiments, a single fluid selector valve can support all of the seed modules within the field housing. In certain such embodiments, a seed module selector valve can be included between the fluid selector valve the second switching valve to select the seed module which will receive the elution fluids. Each seed module can include a respective second switching valve, first multi-position outflow valve, second multi-position outflow valve. included within the field housing, but outside of the respective seed module housing. The plumbing outside of the seed module housings but within the field housing can be supported by the frame. A similar configuration is used for the outflow valves. The third downstream component, e.g., the production hot cell, is external to the respective seed module and external to the field housing.

In accordance with at least one aspect of this disclosure, a system for the production of Pb-212 is provided. The system comprises a Seed Cartridge. The Seed Cartridge includes a housing having therein a solid support configured to retain Th-228 or Ra-224 tightly as a non-dispersible solid while still permitting thoron gas (Rn-220) to diffuse away. Downstream of the Seed Cartridge is a Pb-212 Collection Column where thoron gas decay results in adsorption of Pb-212 to an adsorption medium within the column. Conduit (i.e., tubing) connects the Seed Cartridge and Pb-212 Collection Column, and a pump is used to continually move the thoron gas in a closed circuit from the Seed Cartridge to the Collection Column. The first flow path operates as a closed loop circuit when the system is in a first mode, or a Pb-212 production mode.

In a second mode of operation, or a Pb-212 collection or harvest mode, a plurality of fluids pass through the collection column in a second flow path, which is an open flow path. Disposed within the second flow path is one or more inflow valves upstream of the collection column configured to flow one or more fluids through the collection column to elute the collection column and one or more outflow valves downstream of the collection column configured to pass the collected Pb-212 to a downstream secondary purification system. The system further includes a switching valve disposed in both the first flow path and the second flow path configured to switch between a first mode of operation in which the first flow path is utilized and a second mode of operation in which the second flow path is utilized, and wherein the switching valve prevents use of the first flow path and second flow path simultaneously.

In certain embodiments, the first flow path is a closed loop flow path, and the second flow path is an open loop flow path.

In certain embodiments, the Pb-212 Collection Column includes an adsorption medium, the adsorption medium being or including titanium (e.g., Grade 2 titanium) In certain embodiments, the titanium can be packed within the collection column in the form of metal beads. In certain embodiments, the titanium can be in the form of porous sintered foam.

In certain embodiments, a filter can be disposed in the first flow path downstream of the Seed Cartridge configured to prevent any breakthrough Th-228 or Ra-224 or decay intermediates from entering the Pb-212 Collection Column.

In certain embodiments, a moisture trap can be disposed in the first flow path upstream and/or downstream of the pump configured to reduce or eliminate moisture within the first flow path to prevent washout of the source. In certain embodiments, the pump can be or include a peristaltic pump.

In certain embodiments, the one or more inflow valves can be or include a multi-position fluid selector valve configured to pass one fluid of a plurality of fluids from a respective fluid source to the collection column based on a position of the multi-position fluid selector valve. In certain embodiments, the multi-position fluid selector valve can be a six-position fluid selector valve configured to pass one of a selection of five fluids through the Pb-212 Collection Column based on a position of the six-position fluid selector valve. In certain embodiments, the fluids can include, water, 95% ethanol, nitric acid, sodium acetate, and dry nitrogen. The 6th position can be a plug that prevents flow through the valve, or otherwise is an “off” position.

In certain embodiments, the one or more outflow valves can be or include a multi-position fluid selector valve configured to pass one fluid of a plurality of fluids from the collection column to a fluid destination based on a position of the multi-position fluid selector valve.

In certain embodiments, in a sixth position, the inflow six-position fluid selector valve is configured to block passage of any fluid, and in a second position, the inflow six-position fluid selector valve is configured to pass nitric acid to the Pb-212 Collection Column to elute Pb-212. In a third position, the inflow four-position fluid selector valve is configured to pass water to the collection column to wash the Pb-212 Collection Column, in a fourth position, the inflow six-position fluid selector valve is configured to pass ethanol to wash the Pb-212 Collection Column, in a fifth position the six-position fluid selector valve is configured to pass nitrogen to the collection column to dry the Pb-212 Collection Column within the collection column and reset the column further collection.

In certain embodiments, the system further comprises the downstream Pb-212 production hot cell where the purified Pb-212 is accumulated and used in the production of radiotherapeutics.

In certain embodiments, the housing portion and the second housing portion of the seed module can include a first portion and a second portion, where the first portion is configured to be threaded to the second portion to seal between the first portion and the second portion. In certain embodiments, the seed cartridge can be included in the first portion of the seed module housing, and the collection column can be included in the second portion of the seed module housing. In certain embodiments, one or more of: the switching valve, the moisture trap, the pump, and/or the filter are included outside of the housing.

In certain embodiments, the system can include a plurality of seed modules, and the plurality of seed modules configured to be contained within a field housing. The field housing can include a hot cell defining an interior vault space surrounded by a shield, and a rotary table and a frame within the interior vault space. The plurality of seed modules can be mounted to the rotary table.

In certain such embodiments, the one or more inflow valves can include an inflow multi-position seed selector valve disposed in the second flow path downstream of the inflow multi-position fluid selector valve, configured to pass the one or more fluids from the fluid source to a respective seed module based on a position of the inflow multi-position fluid selector valve and a position of the inflow multi-position seed selector valve. In such embodiments, the one or more inflow valves can be operatively connected to and can be supported by the frame.

Still in certain such embodiment, the one or more outflow valves can include an outflow multi-position seed selector valve disposed in the second flow path upstream of the outflow multi-position fluid selector valve, configured to pass the one or more fluids from the collection column of the respective seed module based on a position of the outflow of the multi-position fluid selector valve and a position of the outflow multi-position seed selector valve. In such embodiments, the one or more inflow valves can be operatively connected to and can be supported by the frame.

In certain embodiments, the system can further include a monitoring system disposed within the field housing configured to monitor operation of the system and configured to detect malfunctions and/or conditions likely to cause malfunction.

In certain embodiments, the monitoring system can include colorimetric tape or paper provided on one or more components of each respective seed module within the field housing, configured to indicate to an operator that a malfunction or leak has occurred and maintenance is required.

In certain embodiments, the monitoring system can include an imaging device configured to continuously monitor the interior space of the field housing to detect malfunctions and/or conditions likely to cause malfunction, for example detecting a change in the colorimetric tape or paper provided on one more component of each respective seed module.

In certain embodiments, the system further includes a controller and/or a processor configured to continuously review imaging data collected from the imaging device using one or more recognition techniques to recognize and detect malfunctions and/or conditions likely to cause malfunction and issue an alert to an operator indicating as much. The controller can include a memory configured to store the imaging data to generate a historical record. In certain embodiments, the controller can be configured to perform data analytics on the historical record to improve efficiency and maintenance schedules for the system.

In certain embodiments, controller can be further configured to automatically control the switching valve to switch between the first mode and second mode of operation based on a predetermined switching schedule.

In certain embodiments the controller can be configured to store operational data to generate a historical record of operation of one or more fields to track a life cycle of each respective seed module and respective source included therein, and wherein the controller is configured to perform data analytics on the historical record to develop a replacement schedule for each respective seed module and/or source to minimize downtime during removal, disposal, and replacement of a depleted source and a new source, maximizing Pb-212 yield over time and over the plurality of seed modules within the field or one or more fields.

In accordance with at least one aspect of this disclosure, system for continuous generation and collection of Pb-212 from a Th-228 or Ra-224 source is provided. The system includes, a first housing portion including a cartridge, the cartridge having a Th-228 or Ra-224 source and an adsorption column configured to adsorb the Th-228 or Ra-224 and intermediates during decay into Rn-220, a second housing portion including a collection column for collecting the Rn-220 and configured to adsorb Pb-212 generated from decay of Rn-220 within the collection column, and a pump configured to continually pump the Rn-220 from the cartridge to the collection column.

In certain embodiments, the system further includes a conduit connecting the cartridge, the collection column, and the pump. The conduit be made of or can include one or more sections of tubing, the tubing made of a material compatible with high-energy radioisotopes. A filter can be disposed in the conduit between the cartridge and the collection column configured to prevent any breakthrough Th-228 or Ra-224 or decay intermediates from entering the collection column. A moisture trap can also be disposed in the conduit between the collection column and the pump configured to reduce or remove moisture in the air pumped by the pump. A switching valve can be further disposed in the conduit configured to switch a mode of operation of the system between a collection mode in which Pb-212 is collected in the collection column and an elution mode in which Pb-212 is eluted from the collection column and distributed to a downstream Pb-212 purification system.

In certain embodiments, the conduit can be a first conduit, and the system can include a second conduit, configured to connect to an inlet of the collection column and an outlet of the connection column. In elution mode, the switching valve can be configured to allow passage of a fluid from a fluid source to the collection column to elute, wash, and/or dry the collection column. In certain embodiments, the switching valve can be configured to prevent fluid communication between the first conduit and the second conduit so that no fluid from the second conduit passes through the cartridge.

In certain embodiments, the system can include a handle operatively connected to the first housing portion or the second housing portion to allow for movement of the system by a user. In certain embodiments, the first housing portion can be configured to be threaded to the second housing portion.

In accordance with at least one aspect of this disclosure, a kit is provided. The kit can include a container and a plate mounted to a bottom of the container. The plate can include one or more mounting holes defined therein configured to mount one or more of the systems described herein to the plate and within the container. When the system is mounted to the plate, the first housing portion is mounted to the plate and the second housing portion is upright and closer to a top of the container than to the bottom of the container.

In certain embodiments, the kit can include a plug configured to insert into a bore of the second housing portion having the collection column therein, and a bracket configured to hold the plug within the bore to prevent movement of the collection column within the second housing portion during transport. The kit can further include one or more brackets configured to operatively connect to the first housing portion of the system to prevent movement and rotation of the system within the container during transport. In certain embodiments of the kit, the container and plate can be configured to hold eight systems within the container.

In accordance with at least one aspect of this disclosure, a transport cart (e.g., for transporting any one or more embodiment of a system, or components of a system described herein) includes a wheeled base and tabletop operatively connected to the wheeled base via scissor lift. The tabletop includes a longitudinal extension extending beyond an edge of the tabletop, the longitudinal extension defining a groove therein and having one or more bearings within the groove configured to encourage sliding movement a system from the tabletop and into a field housing.

In accordance with at least one aspect of this disclosure, a handling device (e.g., for connecting one or more conduits of the system shown and described herein) includes, a tong or grasper having a proximal handle portion and a distal grabbing portion, the proximal handle portion configured to actuate the grabbing portion with application of force to the proximal handle portion.

In certain embodiments, the grabbing portion can include a first arm and a second arm, a first strain gauge disposed on the first arm and a second strain gauge disposed on the second arm, and a computer module operatively connected the tong or grasper and each of the first strain gauge and the second strain gauge configured to receive one or more signals indicative of a strain applied to the first arm and the second arm. The computer module can be configured to measure a strain differential between strain applied to the first arm and strain applied to the second arm to determine a torque generated by a user grabbing and twisting a luer lock of the system.

In certain embodiments, the computer module can be configured to notify the user that the torque is above, below, or at a predetermined threshold, where the predetermined threshold is determined as a function of a torque required to turn the lure lock to a position such that the luer lock will not leak or break.

In accordance with at least one aspect of this disclosure, a Th-228 farm for continuous generation and collection of high purity Pb-212 for use in manufacturing radiotherapeutics or radiopharmaceuticals is provided. The farm can include, any one or more embodiment of the system described herein, including a plurality of systems. In certain embodiments, the farm can further include one or more transport carts and one or more handling devices. In certain embodiments, each of the plurality of systems, the one or more transport carts, and the one or more handling devices can all be included in the kit. The farm can further include a Pb-212 purifier, and in certain embodiments, the Pb-212 purifier is or includes a Pb-212 resin.

In accordance with at least one aspect of this disclosure, a method is provided, the method comprising, operating a switching valve to automatically switch a mode of operation of a system between a Pb-212 collection mode and a Pb-212 elution mode.

In accordance with at least one aspect of this disclosure, a method for continuous generation and collection of Pb-212 from a Th-228 or Ra-224 source is provided. The method can include, continuously pumping air through a first flow path to push gaseous Rn-220 generated from decay of the Th-228 or Ra-224 source to a collection column disposed in the first flow path downstream of the Th-228 or Ra-224 source until the collection column is at capacity, automatically operating a switching valve to switch a mode of operation from a Pb-212 collection mode to a Pb-212 elution mode, wherein pumping air through the first flow path is stopped, sequentially passing a sequence of fluids through a second flow path to elute the Pb-212 in the collection column, wash the collection column, and/or dry the collection column until the collection column is reset, and automatically operating the switching valve to switch the mode of operation from the Pb-212 elution mode to the Pb-212 collection mode, wherein passing the sequence of fluids through the second flow path is stopped and pumping air through the first flow path is resumed. In certain embodiments, the method can further include continuously and iteratively automatically operating the switching valve to automatically switch between the Pb-212 collection mode and the Pb-212 elution mode until the Th-228 source is depleted.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a diagram showing a radioactive decay scheme of Th-228 in accordance with this disclosure;

FIG. 2 is a diagram showing the energies of the decay of Pb-212 to Pb-208;

FIG. 3 is a diagram of the decay scheme of FIG. 2, additionally showing the respective x-rays and gamma rays released;

FIGS. 4A and 4B show simplified schematic diagrams of a portion of an exemplary configuration of system for continuously producing and collecting a daughter isotope from a parent isotope where FIG. 4A shows a first mode of operation, producing the daughter isotope and FIG. 4B shows a second mode of operation, collecting the daughter isotope;

FIGS. 5A and 5B show more detailed schematic diagrams of a portion of an exemplary configuration of system for continuously producing and collecting a daughter isotope from a parent isotope where FIG. 5A shows a first mode of operation, producing the daughter isotope and FIG. 5B shows a second mode of operation, collecting the daughter isotope;

FIG. 6 is a schematic diagram showing an exemplary embodiment of a valving system in accordance with this disclosure, for collecting the daughter isotopes from a collection column, where the valving system of FIG. 6 operates to control the flow of fluids into the system of FIGS. 5A and 5B;

FIG. 7 is a schematic diagram of a portion of the valving system shown in FIG. 6 showing the connection to the system of FIGS. 5A and 5B;

FIG. 8 is a schematic diagram showing the exemplary configuration of system for continuously producing and collecting a daughter isotope from a parent isotope, showing the portions shown in FIGS. 5a and 5B in conjunction with the valving system shown in FIG. 6, wherein the system is shown in a first mode of operation, producing the daughter isotope;

FIG. 9 shows the system of FIG. 9 in a second mode of operation, passing an eluent for collecting the daughter isotope;

FIG. 10 shows the system of FIG. 9 in the second mode of operation, passing one or more washing fluids for preparing the system to return to the first mode of operation;

FIG. 11 is a schematic view of another embodiment of a system for continuously producing and collecting a daughter isotope from a parent isotope;

FIG. 12 is a schematic view of another embodiment of a system for continuously producing and collecting a daughter isotope from a parent isotope;

FIGS. 13A and 13B show an enlarged localized schematic view of an exemplary embodiment of a tandem seed cartridge of the seed module shown in FIG. 12, where FIG. 13A shows an exploded perspective view and FIG. 13B shows a cross-sectional of the tandem seed cartridge;

FIGS. 14A and 14B show a schematic views of an exemplary embodiment of a field housing, where FIG. 14 shows a schematic perspective view of the field housing, and FIG. 14B shows a cross-sectional view of the field housing shown in FIG. 114A, schematically showing an interior of the field housing;

FIGS. 15A and 15B show a schematic top plan view (FIG. 15A) and a schematic perspective view (FIG. 15B) of an exemplary embodiment of a transport plate configured to mount one or more systems of FIG. 12 within a container during transport;

FIG. 16 is a schematic perspective view of an exemplary embodiment of a transport cart, for example for transporting the system of FIG. 4 from a container to an installation);

FIGS. 17A, 17B, and 17C show a schematic diagram an exemplary embodiment of another field housing, wherein FIG. 17A shows a top plan view of the field housing, FIG. 17B shows a top plan view of an exemplary mounting plate for mounting the seed module of FIG. 12 within the field housing, and FIG. 17C shows front view of the field housing of FIG. 17A;

FIGS. 18A and 18B are a schematic views of exemplary embodiments of plugs for use when servicing a field housing, such as the field housing of FIGS. 17A and 17B;

FIG. 19 is a schematic diagram of an exemplary embodiment of a system, showing the system attached to an embodiment of the rotary table of FIGS. 17A and 17B, where the field housing is shown removed for clarity;

FIG. 20 is a schematic diagram of an exemplary embodiment of the system of FIG. 19, where a plurality of systems are shown attached to an embodiment of the rotary table of FIGS. 17A and 17B, where each of the systems are included within the field housing, but where the field housing is shown removed for clarity;

FIG. 21 shows an exemplary embodiment of a resin; and

FIGS. 22A and 22B are schematic perspective views of an exemplary embodiment of a handling device, configured to allow a user to handle and connect the various components of the one or more embodiments of the system of FIG. 12, where FIG. 22A shows a top perspective view and FIG. 22B shows a bottom perspective view.

### DETAILED DISCLOSURE OF THE INVENTION

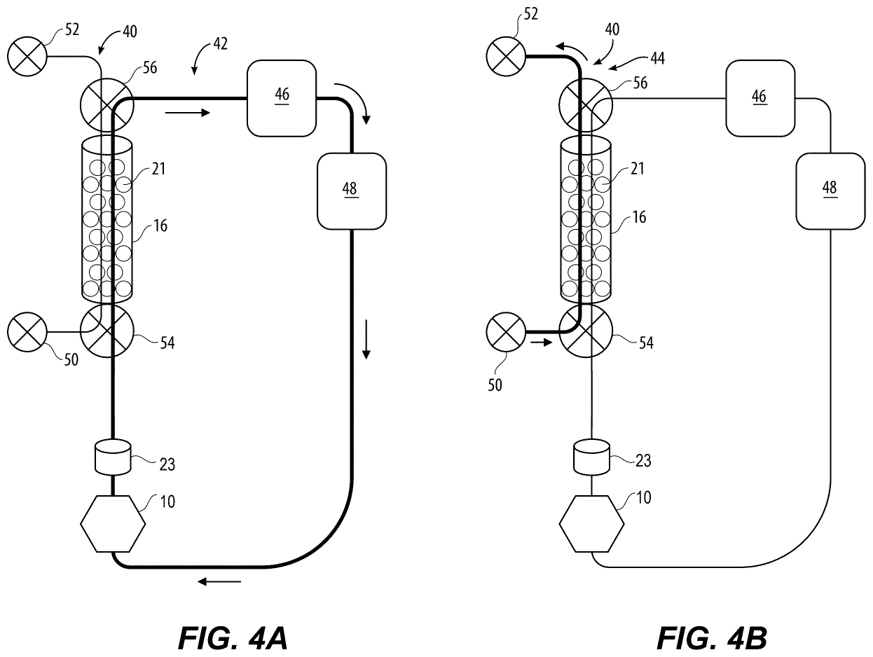

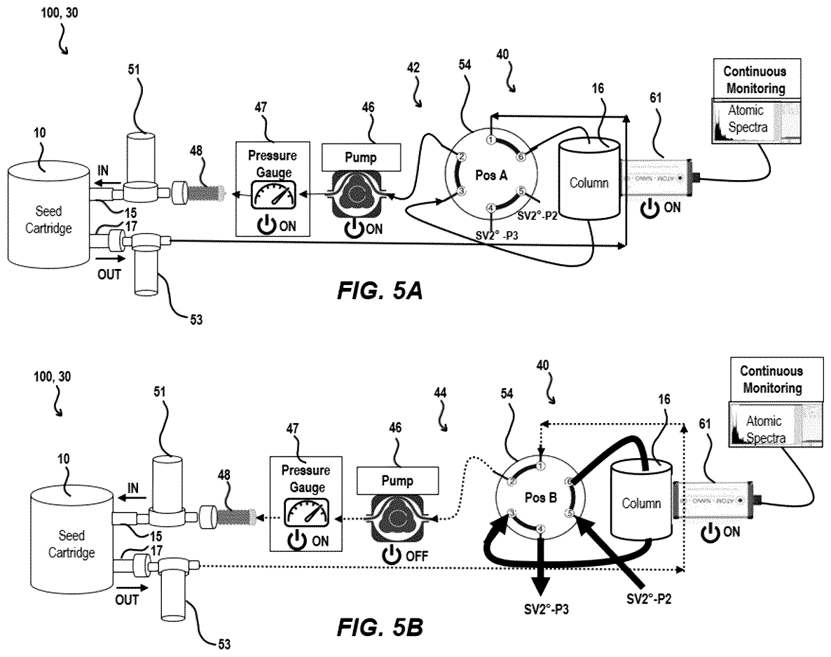

Reference will now be made to the drawings wherein, like reference numerals identify similar structural features or aspects of the subject disclosure. For purposes of explanation and illustration, and not limitation, an illustrative view of an embodiment of a system in accordance with the disclosure is shown in FIG. 4 and is designated generally by reference character 100. Other embodiments and/or aspects of this disclosure are shown in FIGS. 5-22B.

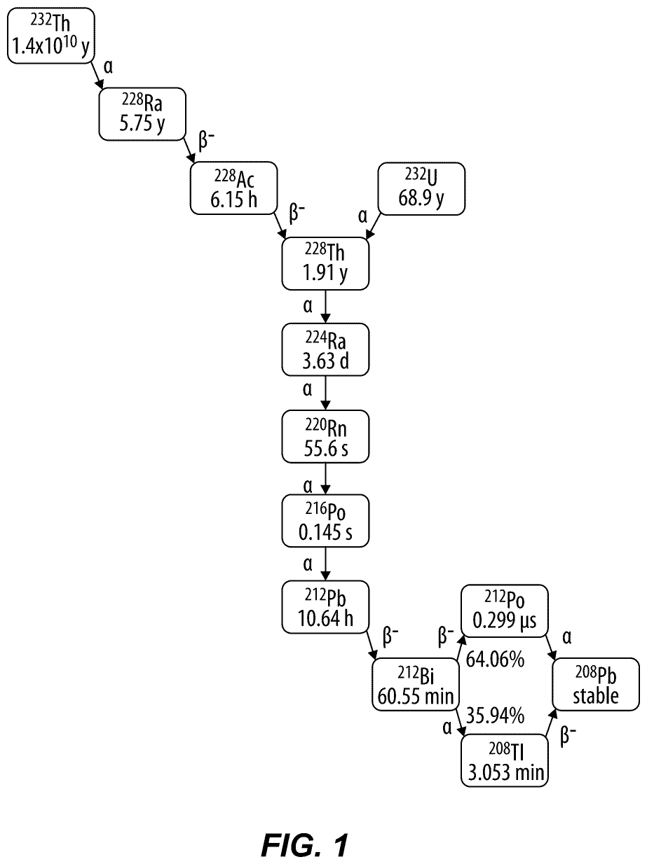

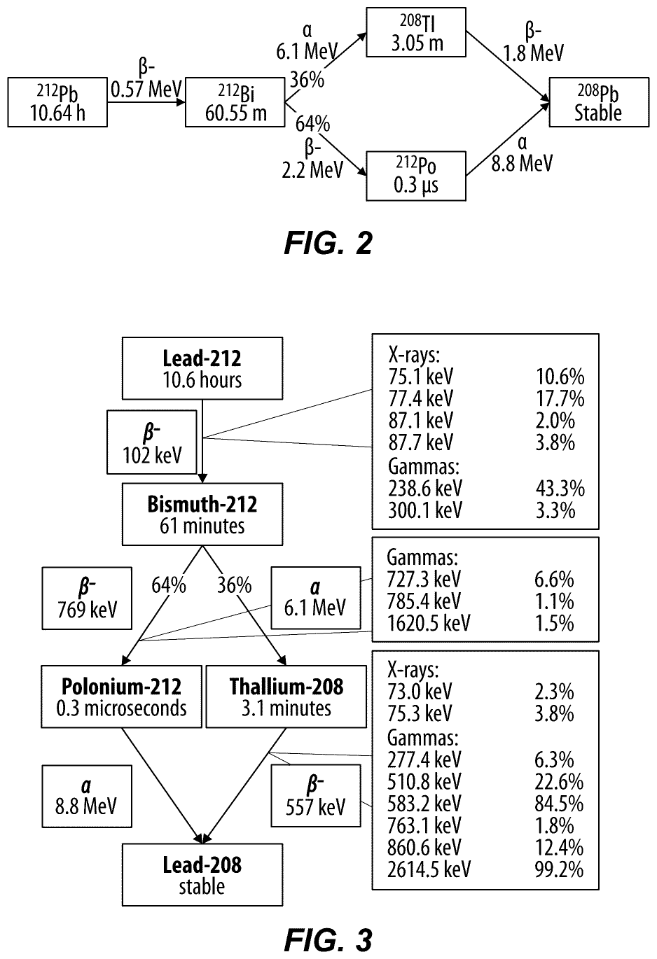

FIG. 1 shows the decay of Th-228. Highlighted in FIG. 1 is the production of gaseous Rn-220, from the decay of solid Ra-224. FIG. 2 shows the relative energies for the decay of Pb-212 to Pb-208. FIG. 3 shows the specific gamma emissions and x-rays (from Kvassheim 2022) for the decay scheme shown in FIG. 2.

To solve the conflicting problems of high-throughput and radiation safety, while maximizing cost-efficiency, time-efficiency, and simplicity, overcoming the challenges noted in published conventional generation techniques, the invention disclosed herein provides a novel system and method for generation of Pb-212 from a source, the source being Th-228 or a decay intermediate of Th-228, such as Ra-224, and using gaseous radon-220 (Rn-220) in a fully-automated system that switches between gaseous and liquid modes of operation.

With reference now to FIGS. 4-22B, embodiments of the invention, as will be described further below, use a novel closed-loop “thoron pump” to ensure that the maximum amount of Rn-220 is extracted from the radiation source (e.g., Th-228 or Ra-224). The inventive system also includes a valve system used to switch from “thoron pump mode” (gaseous) for generating the Pb-212 to “Pb-212 recovery mode” (liquid) for eluting the Pb-212 from the collection column and sending it to a secondary Pb-212 purification column, and ultimately to a Pb-212 production hot cell for using the purified Pb-212 in its application.

In accordance with at least one aspect of this disclosure, there is provided a system for the continuous production of Pb-212, comprising a first flow path and a second flow path. The first flow path is a closed loop fluid circuit for continuously generating Pb-212 from decay of a parent isotope. In the fluid circuit of the first flow path is a collection column that encourages decay of the parent or intermediate isotope into Pb-212 and collects the Pb-212 for harvesting. The first flow path can be a primary Pb-212 purification flow path. The second flow path is an open flow path for circulating a plurality of fluids through the collection column to elute the column and harvesting the Pb-212 for later use, for example in the production of radiotherapeutics. The second flow path can be a secondary Pb-212 flow path such that the Pb-212 that is ultimately accumulated from the system is pure or ultra-pure, suitable for the use in the production of radiotherapeutics. The system includes various components disposed in each of the first and second flow paths, each component will be described further herein.

Though certain embodiments are described herein as using a Th-228 source 12 in the seed cartridge 10, in certain embodiments, the seed cartridge could also utilize a Ra-224 source 12. Such embodiments can produce the same desired levels of Pb-212 as the Th-228 seed cartridge 10. In certain applications the Ra-224 seed cartridge 10 can be replaced on a more frequent schedule than the Th-228 seed cartridge 10, depending on a desired Pb-212 production level.

In certain instances, it is possible the seed cartridge 10 may become contaminated with Th-229 at some point before it is included within the seed module. However, embodiments of the Th-228 seed cartridge 10 are configured and adapted to function as desired, even with significant contamination of Th-229. One having ordinary skill in the art, having the benefit of this disclosure, would appreciate that because Th-229 does not decay to any gaseous daughter isotopes, it is therefore “invisible” to the thoron pump and the Pb-212 collection column 16. In certain embodiments, the capacity (i.e., surface area) of the seed cartridge 10 may be adjusted to account for the non-radioactive and radioactive atoms contributed by Th-229, which can occupy surface area on the seed cartridge 10, and at some level, could block binding of Th-228.

With reference to FIGS. 4-20, an embodiment of a system 100 is shown. The system 100 includes seed cartridge 10, a seed assembly 20, and a seed module 30. Each of these components will be discussed in depth further. An assembled system 100 includes the seed cartridge 10 is housed in the seed assembly 20, and a collection assembly 40 is fluidically connected to the seed assembly 20 to form the seed module 30. As used herein, “system 100” can be used to refer to a single seed module 30 or a plurality of seed modules 30 even though the detailed discussion of the system 100 may refer to only a single seed module 30. The seed cartridge 10 includes a radiation source 12 configured to decay into Pb-212 and intermediates. In certain embodiments, the radiation source 12 can be Th-228 or Ra-224 for example, both of which will decay into gaseous Rn-220 and ultimately Pb-212 (e.g., as shown in FIG. 1).

FIGS. 4A and 4B show a simplified schematic of the collection assembly 40 of the system 100. Shown in FIG. 4A is the system operating in the first mode, Pb-212 production mode. This indicates flow arrows and thick black line, showing flow the through the first flow path 42, which is a closed loop fluid circuit. In the first flow path, there is a radiation source 12, or a parent isotope (e.g., Th-228 or Ra-224) supported on or in a solid support 14 configured to decay into gaseous Rn-220, The source 12 and solid support 14 can be included in a housing 11, collectively referred to herein as the seed cartridge 10.

The seed cartridge 10 includes an inlet 15 and an outlet 17 defined within the housing 11, where the support 14 is between the inlet 15 and the outlet 17. In certain embodiments, such as shown in FIGS. 5A and 5B, for added safety, one or more normally closed (NC) solenoid valves can be placed in the first flow path 42, including a first NC solenoid 51 on the inlet side of the housing 11 and a second NC solenoid 53 on the outlet side of the housing 11. The system can be configured such that energizing the solenoids 51, 53 is required for flow to occur through the housing 11. Since the valves 51, 53 are normally closed, loss of power results in a closed state improving the safety of the system.

In certain embodiments, the solid support 14 can be or include a titanium or titanium compound support, for example, the support can include titanium foam 13, titanium spheres, or another geometric configuration of titanium with high binding capacity (e.g., high surface area), high flow, and low pressure to flow. In certain embodiments, the solid support can be or include an adsorption medium, such as carbon graphite nanotubes (CGN), activated alumina, stainless steel with a phosphate-conversion coating, or the like. The selected solid support can increase stability and/or surface area over conventional quartz wool by at least an order of magnitude and will also be a rigid, stable molecular structure to withstand the significant radiation dose rate.

In certain embodiments, the seed cartridge 10 can be oriented in the first flow path 42 such that the flow from the inlet 15 to the outlet 17 of the seed cartridge 10 flows in a direction of gravity (e.g., wherein the inlet 15 is on a top of the housing 11, and the outlet 17 is on the bottom of the housing 11 as shown in FIGS. 5A and 5B for example). This is because gaseous Rn-220 is approximately seven times denser than air so it will naturally fall to the bottom of the seed cartridge 10 and therefore will require less powerful flow through the cartridge 10 to reach the collection column 16 if oriented in this manner.

The collection assembly 40 further includes the collection column 16 disposed in the first flow path 42 configured to collect the gaseous Rn-220 released from seed cartridge 10. The collection column 16 is packed with a medium 21 configured to adsorb Pb-212 generated from decay of Rn-220 within the collection column 16. In certain embodiments, the medium within the collection column can include metal beads (e.g., titanium or grade 2 titanium beads having a size 1-3 mm), for example configured to induce turbulence into the gas flowing through the collection column 16 thereby encouraging decay into Pb-212. Inducing turbulence in the collection column 16 can increase collision rate of the Rn-220 particles with the beads 21 thereby increasing adsorption to the surface of the beads 21 and increasing residence time within the column 16 maximizing Pb-212 adsorption. Conventional techniques utilize a simple glass bottle or straight-walled chromatography column, however, the collection column 16 described herein utilizes small (e.g., 1-3 mm) titanium beads in a column 16, which can also maintain a relatively low back pressure, which can be desirable.

In certain embodiments, a cooling element can be in thermal communication with the collection column 16 to cool the gas flowing therethrough to a temperature at most below a boiling point of the gas emanating from the seed cartridge 10 (e.g., below −67.1° C.) to prevent the thoron gas from exiting the collection column 16. In certain embodiments, the cooling element can be or include a cryocooler or a dewar cooler or the like.

In certain embodiments, the adsorption medium 21 packed within the collection column 16 can be or include glass beads in a chromatography column, for example. In certain embodiments, the glass beads can be small glass beads (e.g., 0.5-5 mm in size) to maximize surface area while simultaneously maximizing the number of collisions encountered by a Rn-220 gas atom in the column 16.

In certain embodiments, a clean-up filter 23 can be optionally included between the seed cartridge 10 and the collection column 16 to prevent breakthrough and transport of the source 12 or other decay intermediates to the column 16 and the downstream components of the closed loop flow path 42. In certain embodiments, the clean-up filter 23 can be or include an AG resin or a similar material that is configured and adapted to tightly bind Th-228 for Ra-224.

A pump 46 configured to pump air through the first flow path 42 to push the Rn-220 from the seed cartridge 10 to the collection column 16 is disposed in the first flow 42 path between an outlet of the collection column 16 and the inlet 15 of the seed cartridge 10. In certain embodiments, the pump 46 can be or include a peristaltic pump. The pump 46 can be configured to continually pump gas (e.g., thoron gas in air) through the first flow path 42. Using the closed-loop continuous air circulation via a peristaltic pump increases the likelihood that Rn-220 will be blown off the radiation source 12 (e.g., Th-228 or Ra-224) and onto the collection surface (e.g., the beads 21) in the collection column 16 for capture. The active air motion of the first flow path 42 also permits typical chromatography geometries to be used with respect to pumps and columns because since the system 100 and collection assembly 40 does not rely on passive diffusion of Rn-220, which is an improvement over conventional techniques. In certain embodiments, the flow rate from the pump 46 can be adjustable so that a maximum number of Rn-220 gas atoms are blown off the solid support 14, yet all or nearly all are captured in the collection column 16, thereby maximizing Pb-212 production. The pump 46 is configured and adapted to maintain a closed system while circulating air at a chosen flow rate (mL/min). The flow rate can be selected as a function of one or more of the half-life of Rn-220 (55.6 seconds); the “active dead space” (the sum of volumes starting at the solid support 14 within the seed cartridge and ending at the outlet of the column 16), and/or the back-pressure created from the packed medium 21 within the column 16.

In certain embodiments, the flow rate moves 100% of Rn-220 emanating from the seed cartridge 10 into the collection column 16 while ensuring that there are enough collisions in the column to capture 100% of the Rn-220. A flow rate that is too low would mean that some of the Rn-220 will never enter the collection column 16 or that the Rn-220 is all concentrated at the inlet of the collection column 16. A flow rate that is too high would mean that some of the Rn-220 has escaped the outlet of the column 16.

In certain embodiments, a minimum flow rate of the first flow path 42 can be about 1.9 mL/0.927 min or about 2 mL/min. Provided there are adequate collisions, using a higher flow rate increases the probability of minimizing adsorption to the clean-up filter 23 and conduit 19. It is contemplated that flow rates up to 10 mL/min could be suitable. The risk at higher-than-needed flow-rates is that any residual moisture in the air, or atomic-level breakdown of the solid support 14, could result in the radiation source 12 being dislodged from the filter seed module 10 and ending up on the in the collection column 16, where it would appear as “breakthrough” contamination of the final purified Pb-212.

In certain embodiments, the pump 46 can be a 24V peristaltic pump with connecting conduit having a diameter of about 1.6 mm to 2 mm (e.g., about 1/16″ ID) configured to operate at a fixed 4 mL/min. In certain embodiments, a micro flow detector or pressure sensor can be included in the first flow path 42 to ensure that air flow is occurring and to alert an operator to a tubing malfunction if the flowrate is not as expected. Embodiments of the system 100 can include different components based on different environments. For example, the service life of the pump 46 and connected tubing 19 may be monitored to ensure tubing does not rupture. The exact tubing or conduit utilized can be selected to be compatible with high-energy radioisotopes. A pump shell can be divided into plastic shell and stainless steel materials, and chosen based on the environment. The flow ranges for the chosen pump 46 can change, therefore the flow range for the chosen pump 46 can be determined as a function of the environment and application.

In certain embodiments one or more moisture traps (e.g., dehumidifying filters, desiccants, or the like) can be disposed in the first flow path 42 between the outlet of the seed cartridge 17 and the inlet 15 of the seed cartridge 10, for example, for example, downstream of the pump (and upstream of the seed cartridge) configured to reduce or eliminate moisture within the first flow path 42 to prevent washout of the source in the seed cartridge 10. In certain embodiments, a dehumidifier 48 (e.g., a dehumidifying filter) can be included in first flow path 42 downstream of the pump 46 to dry the air prior to passing to the seed cartridge. For example, the system 100 can include a cartridge 48 disposed in the first flow path 42 configured to eliminate moisture in the circulating air flow. The cartridge 48 can be or include a Dry-Rite cartridge or a desiccant like indicator silica gel for example. The dehumidifier will help minimize damage to the seed cartridge 10.

In certain embodiments one or more monitoring devices can be included in the first flow path 42, such as pressure gauges 47 which can be operatively connected to a pressure sensor 59 for continuous monitoring, one or more pressure sensors integrated directly in the flow path 42, and temperature sensors to monitor the pressure and temperature in the first flow path 42. One or more radiation detectors including, for example, radiation PIN detectors 55, 57 or gamma spectrometers 61 can be disposed in the first flow path or otherwise in communication with the first flow path 42 to monitor the composition of the gas flow within the collection column 16 or in the conduit 19 communicating the first flow path 42.

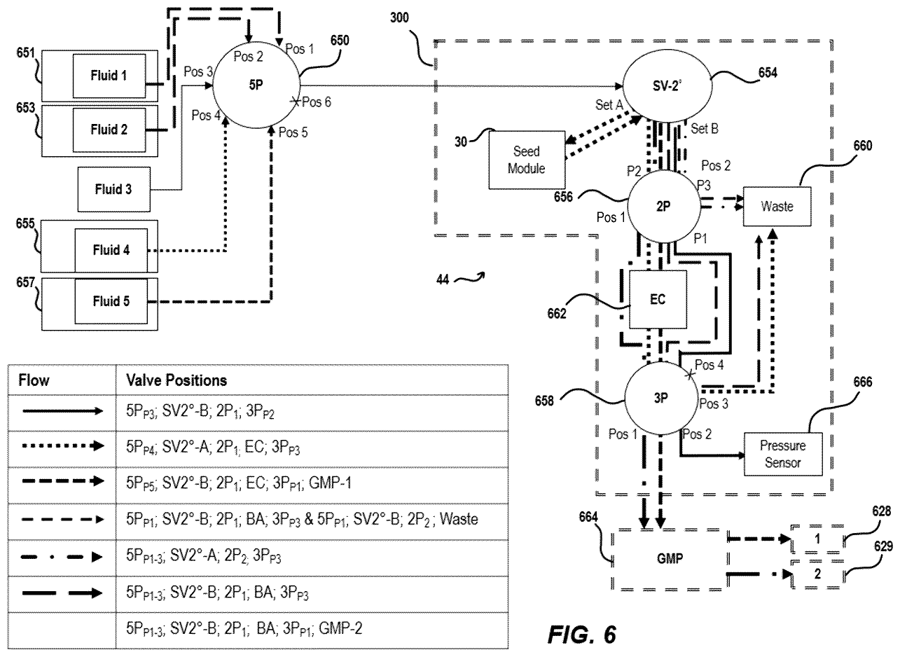

Also shown in FIGS. 4A and 4B, the collection assembly 40 further includes a second flow path 44, which is highlighted in FIG. 4B by the flow arrows and thick black line. Disposed in the second flow path 44 is the collection column 16, an inflow valve 50 upstream of the collection column 16 configured to flow one or more fluids through the collection column 16 to elute the collection column 16, and outflow valve 52 downstream of the collection column 16 configured to pass the collected Pb-212 to a downstream purification system. Embodiments of the inflow and outflow valves 50, 52 will be discussed in greater detail below with reference to FIGS. 6-11, 19, and 20.

In the simplified example embodiment shown in FIGS. 4A and 4B, a first switching valve 54 and a second switching valve 56 are disposed in both the first flow path 42 and the second flow path 44, immediately upstream and downstream of the collection column 16. The switching valves 54, 56 are configured to switch the collection assembly 40 between a first mode of operation in which the first flow path 42 is utilized (shown in FIG. 5A) and a second mode of operation in which the second flow path 44 is utilized (shown in FIG. 5B). The switching valves 54, 56 prevents use of the first flow path 42 and second flow path 44 simultaneously, preventing any liquid from entering the pump 46 and source 12.

In certain embodiments, such as exemplary embodiments that will be described next with respect to FIGS. 6-11, 19, and 20, the selector valves 54, 56 can be replaced with a single selector valve 54 disposed in both the first flow path 42 and second flow path 44 of the collection assembly 40. The single selector valve 54 is integrated into the collection assembly 40 in a unique configuration such that the single valve motion to switch from a Rn-220 generation mode (i.e., recirculating thoron gas) to collection mode (i.e., where the collection column is washed with a diluent, e.g., an acid (for example 0.1-0.4 M HCl or 1 M nitric acid)) which elutes the Pb-212 from the collection column 16 and flows the Pb-212 to a downstream component, such as a resin purifier or a storage container. In certain embodiments, the flow of eluent through the collection column 16 can be in a flow direction opposite of the flow of the gaseous Rn-220 through the collection column (e.g., gaseous flow can be from bottom to top while elution can be top to bottom) to maximize elution efficiency. As noted, FIGS. 4A and 4B show a simplified diagram of the valving. A more detailed discussion of the specific valve configuration and operation will be discussed further herein below.

FIGS. 5A and 5B, show a more detailed schematic view of the components disposed in the first flow path 42 and second flow path 44. FIG. 5A shows system 100 in the first operational mode, where the switching valve 54 is in a first position (e.g., position A) and the flow path 42 is operating in a closed loop fluid circuit. FIG. 5B shows system 100 in the second operation position, where the switching valve 54 is in a second position (e.g., position B) and the eluents, washing, and drying fluids sequentially enter the collection column through the valve 54, but do not enter the first flow path 42 (which is shown in dotted lines in FIG. 5B). Each of the sensors, gauges, and spectrometers can be used to continually monitor the critical parameters of the system to ensure there are no leaks, either in the tubing, in any of the components, or if there is any breakthrough Th-228 or Ra-224 entering the collection column 16. If any critical parameters are determined to be outside of normal operational range, the system can automatically alert an operator and/or shutdown the thoron gas flow through the seed cartridge using the first and second NC solenoid valves 51, 53 on the inlet and outlet of the seed cartridge. In certain embodiments, the first and second NC solenoid valves 51, 53 can be in operative communication with one or more of pressure or temperature sensors, or a system monitoring device configured to automatically shut either or both of the first 51 and/or second 53 NC solenoid valves in response to an error detected in system function (e.g., a leak, an uncharacteristic spike in dose rate, or the like).

Referring now to FIGS. 6-10, the second flow path 44 will be described in further detail. As stated above, the second flow path 44 is only used when the collection column 16 is ready for harvesting the Pb-212, for example when the spectrometer indicates the concentration within the collection column 16 has reached a predetermined a threshold indicative of a “full” column 16 or a particular collection time has expired. Once the threshold is reached, the switching valve 54 can be automatically switched to the second position, position B, to allow the eluents and washing fluids to pass through column 16. The use of a switching valve helps prevent accidental exposure of the dry “thoron pump” components to liquid.

With specific reference to FIG. 6, an exemplary embodiment of the second flow 42 path is shown. The double dashed box labelled 300 schematically represents a field 300, or a hot cell, having within it a seed module 30, which is simply shown as box 30 for clarity in this Figure. The collection column 16 is within the seed module 30, but it is not specifically shown in FIG. 6. In the second flow path 44, a first inflow valve 650 (or “5P valve 650”) is disposed upstream of the inlet of the collection column 16 configured to flow one or more fluids through the collection column 16 to elute the collection column 16 and thereby collect the Pb-212 in a downstream component (e.g., a production hot cell vial 328).

A plurality of fluid sources, e.g., Fluids 1-5 shown in FIG. 6 are fluidically connected to the first inflow valve 650 which is a multi-position fluid selector valve. Since in this embodiment there are five fluids that are passed through the 5P 650, the 5P valve 650 is a six-position selector valve, wherein each fluid is fluidically connected to a respective port of the 5P valve 650 and the sixth position is plugged. In certain embodiments, Fluid 1 can be water or double distilled water and fluidically connected to port 1 of the 5P valve 650, Fluid 2 can be 95% ethanol fluidically connected to port 2 of the 5P valve 650, Fluid 3 can be dry nitrogen fluidically connected to port 3 of the 5P valve 650, Fluid 4 can be nitric acid fluidically connected to port 4 of the 5P valve 650, Fluid 5 can be sodium acetate fluidically connected to port 5 of the 5P valve 650, and port 6 can be plugged and used an “off” position. In certain embodiments, Fluids 1, 2, 4, and 5 can each be controlled by individual syringe pumps 651, 653, 655, 657. FIG. 6 shows a consolidated flow path, where all fluids are shown passing from the 5P valve 650 at the same time and through all positions of the valves, however during operation of the system in the second mode, Fluids 1-5 are sequentially released through the 5P valve 650 according to an elution sequence, which will be described further later.

Downstream of the 5P valve 650 in the second flow path 44 is a second switching valve 654 (or “SV-2° 654”), which is positioned directly upstream of the first switching valve 54 that is included in the seed module 30. The second switching valve 654 is configured to selectively pass the respective fluid from the 5P valve 650 to either the collection column 16 or to another component, bypassing the collection column 16, based on the position of the second switching valve 654. As shown, the second switching valve can be a two-position switching valve, switching between the first position (position A) where fluid from the 5P valve 650 passes to the first switching valve 54 and collection column 16, and a second position (position B) where fluid from the 5P valve 650 bypasses the collection column 16 and the seed module 30 altogether.

One or more outflow valves are disposed in the second flow path 44 and include a first multi-position outflow valve 656 (or “2P valve 656”) and a second multi-position outflow valve 658 (or “3P valve 658”). The 2P valve 656 is disposed in the second flow path 44 downstream of the second switching valve 654 and is configured to pass fluids from the collection column 16 (via the second switching valve 654) to one of a plurality of downstream components based on the position of the 2P valve 656 including a first downstream component 660 and a second downstream component 662. In certain embodiments, the 2P valve 656 can be a two-position selector valve having three ports P1, P2, P3. In the first position of the 2P valve 656, the 2P valve 656 is configured to pass fluid from the second switching valve 654 through port P2 to port P1, to the second downstream component 662, which can be a secondary Pb-212 purifier (e.g., a Pb-212 purifying resin such as an Eichrom column or “E-resin”), or directly to the 3P valve 658. In certain instances, which will be explained with respect to the elution sequence, a bypass adapter BA can be included in order to bypass the secondary Pb-212 purifier 662, thereby directly connecting the P1 port of the 2P valve 656 to the 3P valve 658. In the second position, the 2P valve 656 is configured to pass fluid from the second switching valve 654, through port P2 to port P3, and to the first downstream component 660 which can be a waste collector.

The second multi-position outflow valve, the 3P valve 658, is disposed in the second flow path 42 downstream of the 2P valve 656, and the secondary Pb-212 purifier 660 is disposed between the 2P valve 656 and the 3P valve 658. The 3P valve 658 can be a four-position selector valve. In the first position, the 3P valve 658 is configured to pass fluids from the second switching valve or the second downstream component if the 2P valve 656 is in position 1 to a third downstream component 664, which can be the GMP production hot cell. The GMP hot cell 664 can include a production vial 628 waste collector 629. In the second position, the 3P valve 658 is configured to pass fluids from the second switching valve 654 to the fourth downstream component 666 which can be a pressure sensor 666 in a capped dead-end channel 667 used for pressure testing the system. In the third position, the 3P valve 658 is configured to pass fluids from the second switching valve 654 or the secondary Pb-212 purifier 662 to the waste collector 660. The fourth position of the 3P valve 658 can be plugged, or an “off” position.

Still with reference to FIG. 6, the elution sequence will now be described. The schematic in FIG. 6 assumes the first switching valve 54 inside the seed module 30 is already set to the second position, to set the seed module 30 into the second mode in preparation for elution. Once the seed module 30 is set, a dry pressure test is performed on the second fluid path 44 to ensure that no leaks are present in the system. The dry pressure test uses dry nitrogen flowing through the 5P valve 650, the second switching valve 654 (SV-2°), the 2P valve 656 in position 1 (i.e., from port P2 to port P1), the 3P valve 658 in position 2 and into the dead end channel with pressure sensor 666.

| Elution | | 5P Valve | SV-2° | 2P Valve | 3P Valve |
|---|---|---|---|---|---|
| step | Liquid | Pos | Pos | Pos | Pos |
| 1 | N₂ | P3 | B | 1 | P2 |

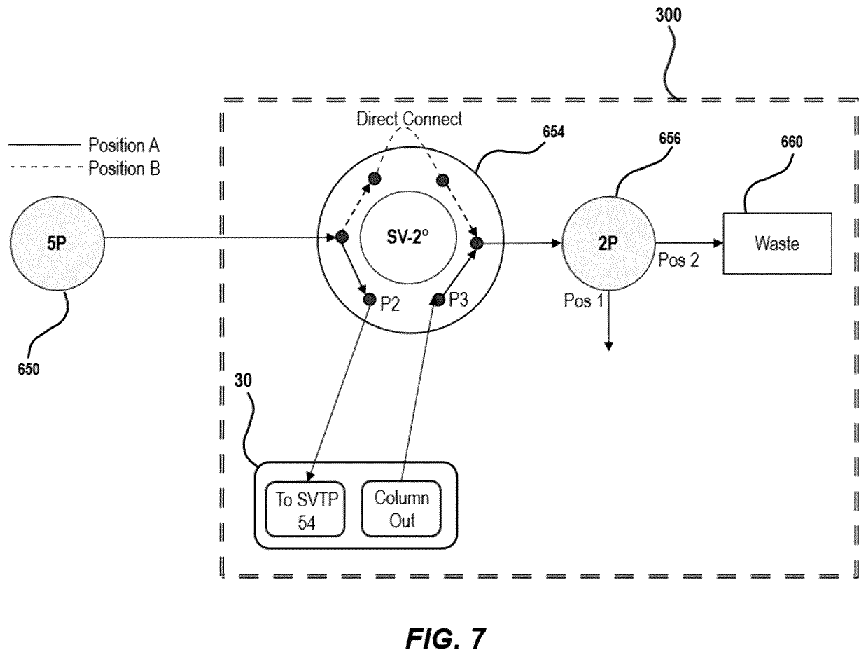

After the leak test is performed and determined to be successful, the second switching valve 654 is set to position A for sending eluent to the collection column 16 within the seed module 30 and the secondary Pb-212 purifier is connected to the second flow path 44. The flow through the secondary switching valve 654 is shown in greater detail in FIG. 7. To elute the collection column 16, Fluid 4 nitric acid (HNO₃; typically 1 N) flows through port 4 of the 5P valve 650, through the second switching valve 654 to the first switching valve 54 (SVTP), through the collection column 16, back through the first switching valve 54, back to the second switching valve 654, to the 2P valve 656 set to position 1 (i.e., from port P2 to port P1), through the secondary Pb-212 purifier 662, to the 3P valve 658 set to position 3, and to the waste collector 660. The Pb-212 eluted from the collection column 16 is now stored in the secondary purifier 662, while the remaining nitric acid is discarded.

| Elution | | 5P Valve | SV-2° | 2P Valve | 3P Valve |
|---|---|---|---|---|---|
| step | Liquid | Pos | Pos | Pos | Pos |
| 2 | HNO₃ | P4 | A | 1 | P3 |

Since the collection column 16 is now completely cleared of Pb-212, the secondary switching valve 654 is moved to position B to disconnect and fluidly isolate the seed module 30 from the second flow path 44. The secondary Pb-212 purifier 662 (e.g., the Eichrom) is now eluted with sodium acetate (e.g., 1 M NaAc). The 5P valve 650 is set to position 5 to allow the sodium acetate to enter the flow path, passing through the second switching valve 654 in position B, the 2P valve 656 in position 1 (from port P2 to port P1), the 3P valve 658 in position 1 and to the GMP hot cell vial 628 for use in application later.

| Elution | | 5P Valve | SV-2° | 2P Valve | 3P Valve |
|---|---|---|---|---|---|
| step | Liquid | Pos | Pos | Pos | Pos |
| 3 | NaAc | P5 | B | 1 | P1 |

After the hot cell vial 628 is removed from the flow path and the transfer tubing inserted into waste, the second fluid path 44 is now flushed with water (e.g., double distilled water ddH₂O) to clear any remaining NaAc from the elution path, which can be done in two steps. The water enters through port of the 5P valve 650, to the second switching valve 654 in position B, to the 2P valve 656 in position 2 (port P2 to port P3) to pass the contaminated water to the waste collector 600. Then, the 2P valve 656 is switched to position 1 (port P2 to port P1) to direct the clean water to the 3P valve 358, which passes the contaminated water to the waste collector 660 via position 3. In certain embodiments, the bypass adapter BA can be connected between the 2P valve 656 and the 3P valve 658 to bypass the secondary purifier 662 thereby allowing flow to pass through position 1 of the 2P valve 656 directly to position 3 of the 3P valve 658.

| Elution | | 5P Valve | SV-2° | 2P Valve | 3P Valve |
|---|---|---|---|---|---|
| step | Liquid | Pos | Pos | Pos | Pos |
| 4 | ddH₂O | P5 | B | 2 | n/a |
| 5 | ddH₂O | P5 | B | 1 | P3 |

Once the elution path outside of the seed module 30 is clean, the portion of the second fluid path 44 within the seed module (e.g., passing through the collection column 16) is washed in three steps. Second switching valve 16 is set to position A to re-engage see module 30 to wash and dry the collection column with water, ethanol (e.g., 95% EtOH) and dry nitrogen, sequentially. The valves remain in the same position for each washing fluid in this step of the process, with the exception of the 5P valve 650 which switches to select the fluids. The 5P valve 650 selects water for the first wash using position 1, provides the water to the collection column 16 through the second switching valve 654 in position A, from the collection column 16 back to the second switching valve 654, to the 2P valve 656 in position 2 (port P2 to port P3), and to the waste collector 660 for disposal. The same sequence occurs for each of the ethanol and nitrogen.

| Elution | | 5P Valve | SV-2° | 2P Valve | 3P Valve |
|---|---|---|---|---|---|
| step | Liquid | Pos | Pos | Pos | Pos |
| 6 | ddH₂O | P1 | A | 2 | n/a |
| 7 | EtOH | P2 | A | 2 | n/a |
| 8 | N₂ | P3 | A | 2 | n/a |

Once the collection column is completely dry, the first switching valve 54 inside the seed module 30 can return to position A, where the pump 46 is restarted and the seed module 30 restarts Pb-212 production mode. The restart of Pb-212 production mode can happen while the elution cleaning continues in the elution flow path 44, since the first switching valve 54 being in position A and the second switch valve 654 being in position B fluidically isolates the first flow path 42 from the second flow path 44. While the seed module 30 returns to production mode, the second switching valve 654 returns to position B and the 3P valve moves to position 3.

| Elution | | 5P Valve | SV-2° | 2P Valve | 3P Valve |
|---|---|---|---|---|---|
| step | Liquid | Pos | Pos | Pos | Pos |
| 9 | n/a | P6 | B | 2 | n/a |

During this time, e.g., in step 9, the elution pathway 44 can enter a standby mode while the secondary Pb-212 purifier is removed from the second flow path 44 and discarded. The bypass adapter can be connected between the 2P valve 656 and the 3P valve 658 in place of the secondary purifier 662. At steps 10-12, the elution path 44 is then washed and dried with, in order, water, ethanol, and dry nitrogen similar to how the collection column 16 is washed and dried, with the exception that the second switching valve 654 is in position B and that the fluid passes to both the 2P valve 656 and the 3P valve 658. During each of steps 10, 11, and 12, only the 2P valve 656 moves, from position 1 to position 2 to direct the flow to the waste collector 660 through both the 2P valve 656 and the 3P valve 658. Between each step 10, 11, 12, the 5P valve moves to select the appropriate washing fluid. After this washing and drying step, the pathway through position 3 of the 3P valve 658 is clean and dry.

| Elution | | 5P Valve | SV-2° | 2P Valve | 3P Valve |
|---|---|---|---|---|---|
| step | Liquid | Pos | Pos | Pos | Pos |
| 10 | ddH₂O | P1 | B | 1, 2 | P3 |
| 11 | EtOH | P2 | B | 1, 2 | P3 |
| 12 | N₂ | P3 | B | 1, 2 | P3 |

The Pb-212 in the GMP hot cell vial 628 can now be utilized to produce radiotherapeutics. Once the collection in the hot cell vial 628 is complete, an operator can be notified and the GMP transport tube portion of the elution pathway 44 can be washed and dried by sequentially sending in water, ethanol, and nitrogen through the same sequence described in steps 10-12. Here, the bypass adapter can remain connected between the 2P valve 656 in the first position to the 3P valve 658 in the first position.

| Elution | | 5P Valve | SV-2° | 2P Valve | 3P Valve |
|---|---|---|---|---|---|
| step | Liquid | Pos | Pos | Pos | Pos |
| 13 | ddH₂O | P1 | B | 1, 2 | P1 |
| 14 | EtOH | P2 | B | 1, 2 | P1 |
| 15 | N₂ | P3 | B | 1, 2 | P1 |

Now, the inputs of the 5P valve 650 are the only components remaining to be cleaned. Accordingly, the 5P valve 650 can be sequentially with water, ethanol and nitrogen in the same manner as with steps 13-15 with the bypass adapter still connected between the 2P valve 656 in the first position (port P2 to port P1) to the 3P valve 658 in the third position. After completion of step 18, all tubing within the elution pathway 44 is now clean and dry and the system is ready to begin the elution process again.

| Elution | | 5P Valve | SV-2° | 2P Valve | 3P Valve |
|---|---|---|---|---|---|
| step | Liquid | Pos | Pos | Pos | Pos |
| 16 | ddH₂O | P1 | B | 1 | P3 |
| 17 | EtOH | P2 | B | 1 | P3 |
| 18 | N₂ | P3 | B | 1 | P3 |

Once the cleaning is complete after step 18, all valve and inputs can be set to their initial positions so that the system is ready to perform the pressure test to confirm all components are working properly and without leaks.

| Elution | | 5P Valve | SV-2° | 2P Valve | 3P Valve |
|---|---|---|---|---|---|
| step | Liquid | Pos | Pos | Pos | Pos |
| 19 | N₂ | P3 | B | 1 | P2 |

In certain embodiments, the seed cartridge can be housed within a seed module housing. The first flow path and at least a portion of the second flow path can be fully contained within the seed module housing. In certain embodiments, the seed module housing can include a first portion and a second portion, and the seed cartridge can be included in the first housing portion and the collection column and at least a portion of the first and second flow paths can be housed within the second housing portion. A plurality of seed modules can be configured to be contained within a field housing, and each seed module can be individually fluidically connected to the second flow path. In certain embodiments, both of the seed module housing and the field housing can include lead shielding properties (e.g., the housing can be or include lead, tungsten, or include other shielding properties), where the field housing can be a Pb-212 purification hot cell 302 as described later.

In certain embodiments, the field housing 302 defines an interior vault space surrounded by lead shielding components. Within the interior vault space, a rotary table and a frame can be included to support the seed modules, where the plurality of seed modules can be mounted to the rotary table within the interior space of the field housing. In certain embodiments, the 5P valve 650 can be operatively connected to be supported outside of the interior vault space. In certain embodiments, a single fluid selector valve can support all of the seed modules within the field housing. In certain such embodiments, a seed module selector valve can be included between the fluid selector valve the second switching valve to select the seed module which will receive the elution fluids. Each seed module can include a respective second switching valve, first multi-position outflow valve, second multi-position outflow valve. included within the field housing, but outside of the respective seed module housing. The plumbing outside of the seed module housings but within the field housing can be supported by the frame. A similar configuration is used for the outflow valves. The third downstream component, e.g., the production hot cell 664, is external to the respective seed module 30 and external to the field housing 302.

With reference now to FIGS. 8-10, FIGS. 8-10 show an animation of the flow through the first flow path 42 and the second flow path 44 based on the position of the valves described above. FIG. 8 shows the Pb-212 production mode, the primary Pb-212 purification. As can be seen in FIG. 8, the 5P valve 350 is not connected to the seed module 30, and it remains in fluid isolation from the second flow path. The first flow path 42 operates as described with respect to FIGS. 5A and 5B and is shown in thick black lines in FIG. 8.

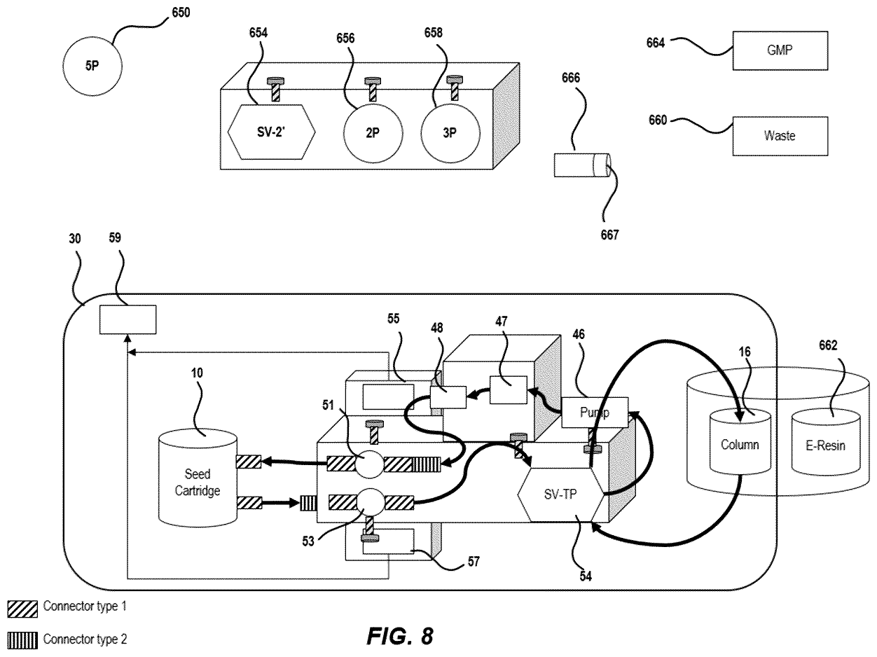

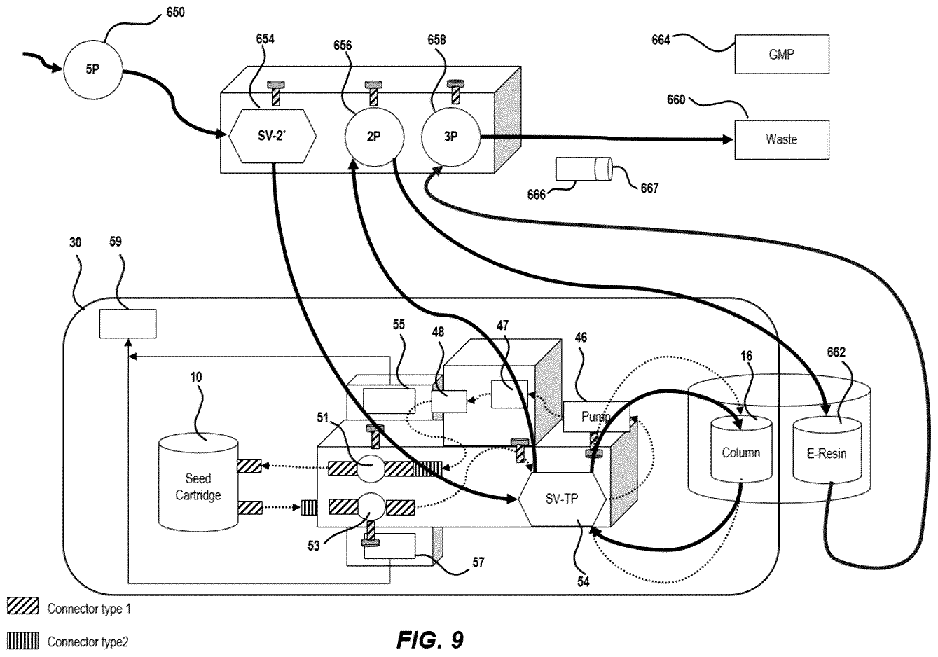

In FIG. 9, the first flow path 42 is stopped, and disconnected from the collection column 16. The first flow path 42 is shown in dotted lines in FIG. 9 while the second flow path 44 (the elution flow path) is shown in thick black lines. Here, the elution pathway, the second flow path 44, is activated by placing the 5P valve 650 into position 4, and the second switching valve is placed in position A to send the eluent (nitric acid) into the collection column 16 to harvest the first purified Pb-212. As shown, the eluent passes through the second switching valve 654 to the first switching valve 54 (SVTP), to the collection column 16, back to the first switching valve 54, to the 2P valve 656 to the secondary Pb-212 purifier (e.g., the E-resin) 662, to the 3P valve 358, then to the waste 660. The spent eluent is discarded, while Pb-212 from the collection column 16 is now held in the secondary purifier 662.

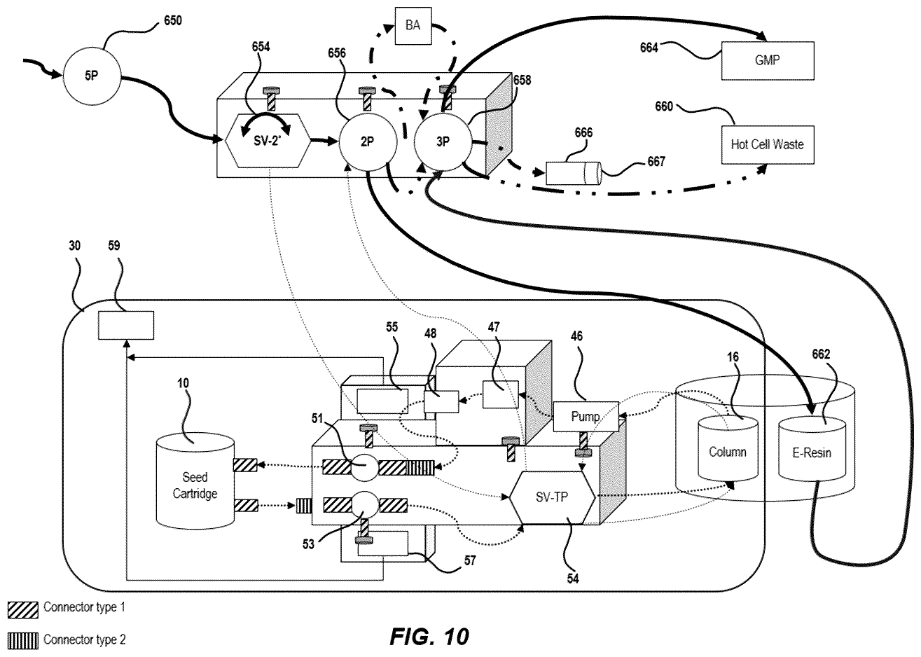

In FIG. 10, the elution of the secondary purifier is shown in thick solid lines, while the inactive pathways are shown in dotted lines. Fluid passes from the 5P valve 650, through the secondary switching valve 654 in position B, through the 2P valve 656 to the secondary purifier 662, to the 3P valve 658, then to GMP hot cell 664 and to the vial 628. In FIG. 10, the thick dot-dash and dot-dot-dash lines show alternate pathways the fluid can take, for example in the pressure test step or in a cleaning step that uses the bypass adapter BA, sending spent cleaner to waste.

Also shown in FIGS. 8-10, the seed cartridge 10 can be connected to the first flow path using multiple connector types. For example, the inlet 15 and outlet 17 of the seed cartridge housing 11 can have structural features configured to connecting the conduit 19 to the housing 11. The structural features can be configured for coupling with a first connector type, such as an IDEX Luer lock female connector and/or a second connector type such as a 5 μm Air Filter Luer or a 5 mm threaded female connector. In certain embodiments, such as shown, both of the first connector type and the second connector type can be utilized in conjunction with one another, where the Luer connector (connector type 1) is included upstream of the seed cartridge inlet connector 15 and also included downstream of the seed cartridge outlet 17, but upstream of the NC valve 53. In certain embodiments, the conduit 19 connecting the plumbing in the system 100 can be or include chemically-resistant, clear, 1/16″ ID, ⅛″ OD FEP tubing and flangeless ¼″—28 fittings or stainless steel tubing of 1/16″ ID.

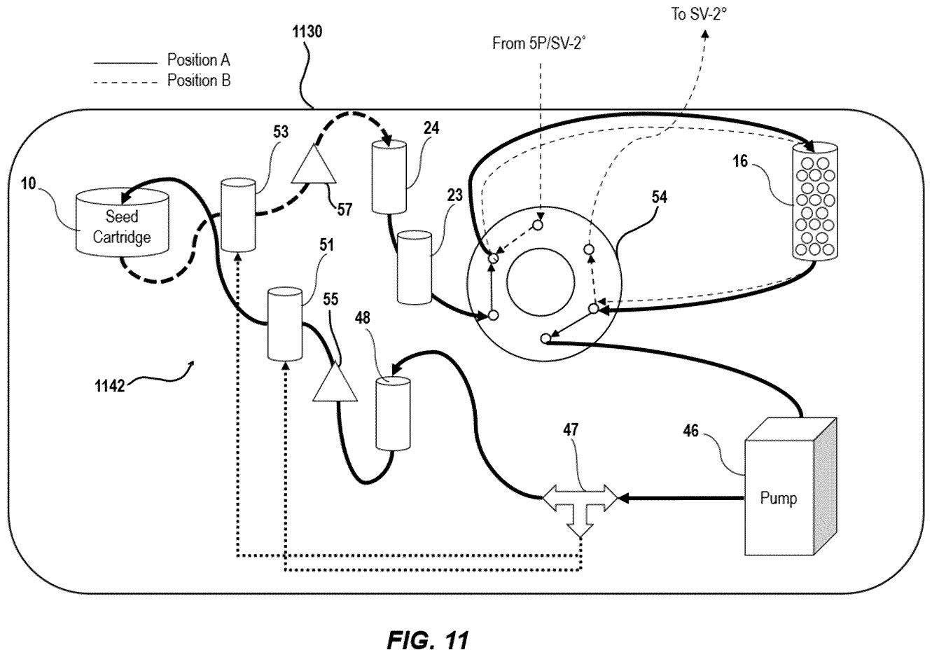

FIG. 11 shows another exemplary embodiment of the system 100, wherein the seed module 1130 is shown in isolation from the valves and plumbing of the second flow path 44. Here, the first flow path 1142 is similar to the flow path 42, and further includes the NC solenoid valves 51, 53, where valve 51 is disposed upstream of the seed cartridge and valve 53 is disposed downstream of the seed cartridge. In this embodiment, the pressure sensor 47 can be in operative communication with the valves 51, 53 to automatically close the valves 51, 53 if there is a malfunction detected in the flow path 1142, such as a sudden increase or decrease in pressure sensed by the pressure sensor/gauge 47, or automatically shut the flow through the seed cartridge 10 in a loss of power, for example. Also included in the flow path 1142 are PIN detectors 55, 57, or PIN diodes, for the continuous monitoring and measurement of ionizing radiation in the flow path 1142 while the system operates in Pb-212 production mode. The PIN detectors 55, 57 can be in operative communication with the controller 350 to store the data collected from detectors 55, 57, and the controller 350 can be configured to control (e.g., automatically) one or more aspects of the system based on the data collected from the PIN detectors 55, 57.

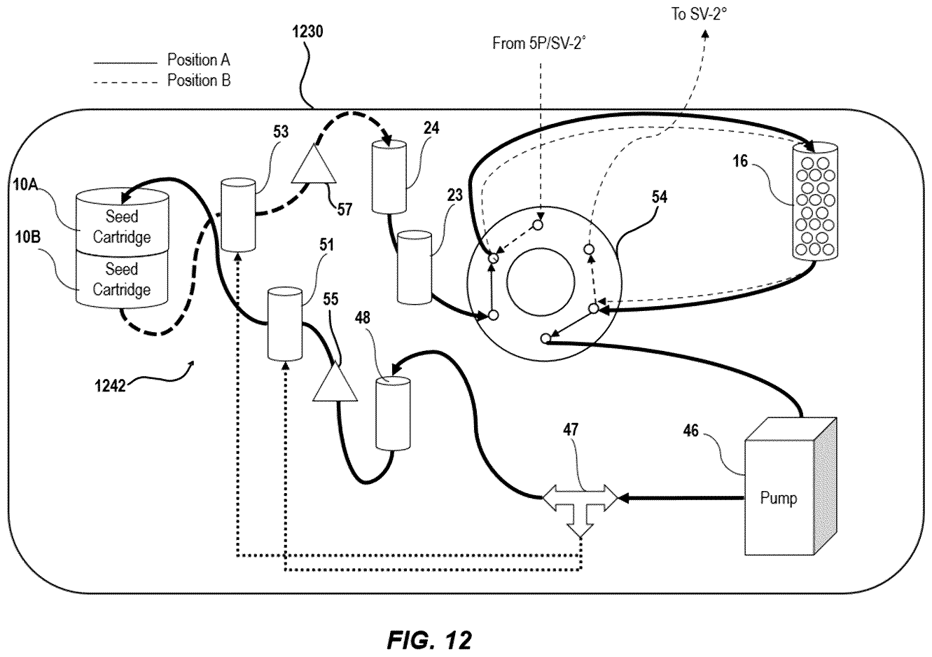

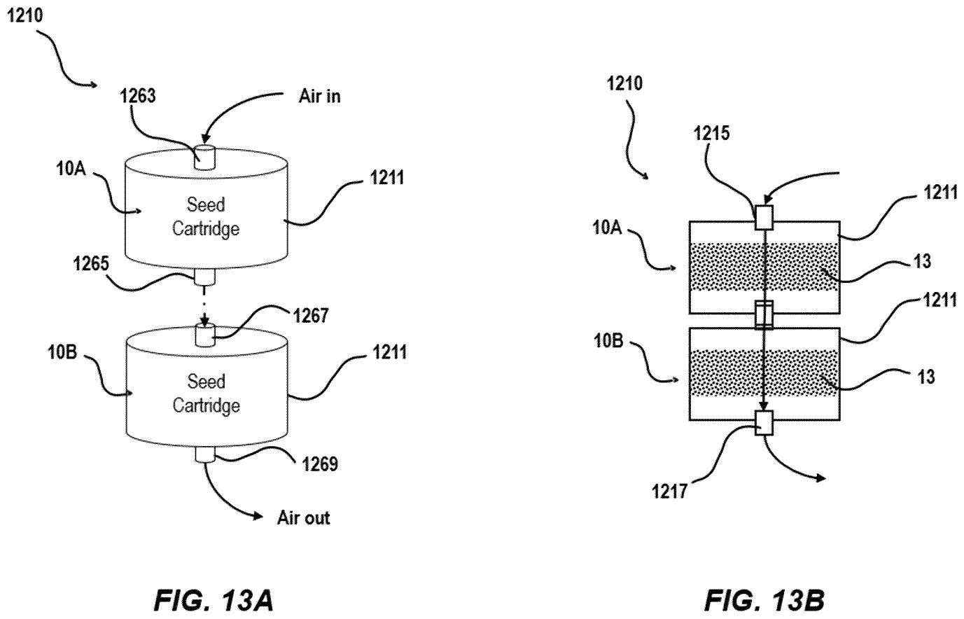

Shown in FIGS. 12-13B, another exemplary embodiment of the system 100, wherein the seed module 1230 is shown in isolation from the valves and plumbing of the second flow path 44. Here, the first flow path 1242 is similar to the flow path 42 and 1142 but further includes 2 seed cartridges 10A and 10B threaded or locked together in series in the flow path 1242. As more clearly in FIGS. 13A and 13B, each seed cartridge housing 1211 includes an inlet Luer Lock 1263, 1267 extending from a respective proximal face and an outlet Luer Lock 1265, 1269 extending from a respective distal face. The outlet Luer Lock 1265 of the first seed cartridge 10A can be connected to the inlet Luer Lock 1267 of the seed cartridge 10B. FIG. 13A shows the two seed cartridges 10A and 10B exploded from one another, while the cross-sectional view of FIG. 13B shows the two cartridges locked together. Including the Luer Locks on the seed cartridge 10 in this manner allows an operator to very quickly remove and insert a new cartridge into the seed module when the cartridge is depleted, either by replacing the old cartridge, or by inserting the new cartridge into the flow path in series in the same flow path. This is advantageous, because it allows a fresh cartridge to be placed into the flow path before the old cartridge is depleted, and for at least the time both cartridges are connected, there will be greater Pb-212 production in the system than if only one cartridge is connected. The number of stacked cartridges is not so limited, though only two are shown for simplicity. In certain applications, the number of cartridges can be selected based on the size of the field housing, for example.

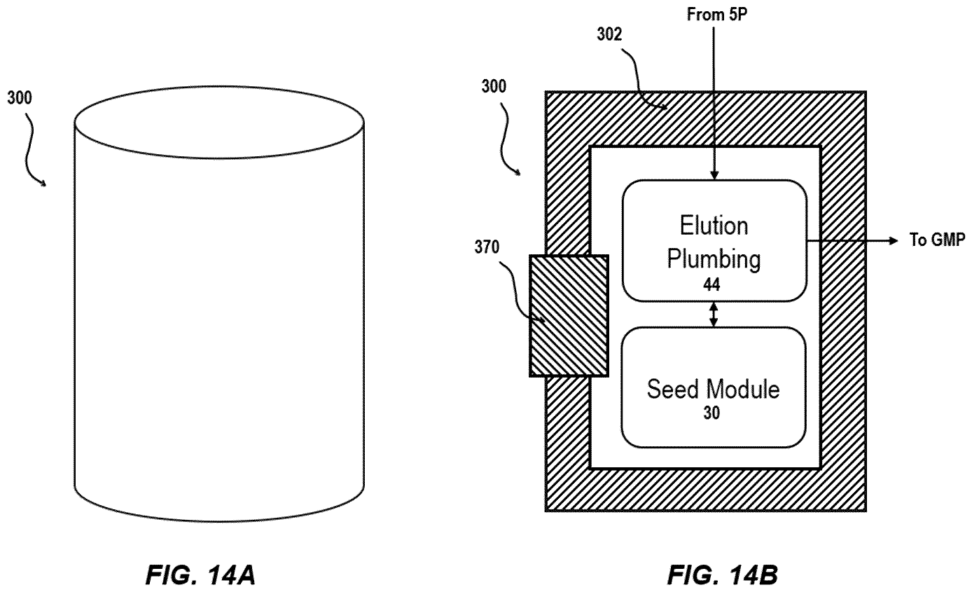

FIGS. 14A and 14B show an exemplary embodiment of the field housing or referred to as the hot cell. FIG. 14A shows a schematic perspective view of the field housing 300, which can be cylindrical in shape. FIG. 14B shows a schematic cross-sectional view of the field housing 300, where the walls 302 of the housing can be a thick lead shield, as shown. An interior space 308 is defined within the walls 302 where the seed module 30 and at least some of elution plumbing (i.e., the valves described in FIG. 6 and conduit connecting the plumbing to the seed module 30). The field housing 300 can include an access insert 370, which can be removed from the field housing 300 to provide an entry into the interior space 308 for maintenance or add/remove seed cartridges, for example. As shown in FIG. 14B, the 5P valve 650 is included outside for the field housing, as is the GMP production hot cell.

In certain embodiments, the system 100 can include a controller, e.g., controller 350 in operative communication with each of the 5P valve 650, the first fluid selector valve 54, the second fluid selector valve 654, the 2P valve 656, the 3P valve 658, the pressure and temperature sensors included in the first flow path, the pressure sensor in the second flow path, the pump, and the spectrometer. The controller 350 can be configured to receive signals from each of these components to continually monitor the state of the system 100. The controller 350 can be configured to automatically control the positions of the valves, based on the pre-programmed operational sequence, for example or based on sensor readings. In certain embodiments, the system can include a human machine interface (“HMI”) configured to display the status of the system. In certain embodiments, the HMI can include a graphical user interface (“GUI”) for allowing an operator to interact with the system, for example to allow for manual control of at least some of the valves if needed or desired. The GUI can be configured to receive user input and control one or more components of the system based on the user input.

In certain embodiments, the GUI can be configured to display each step of the elution sequence as it occurs, either in written or graphical form to aid the operator. In certain embodiments, the system can be configured to display the steps of the elution sequence that require operator intervention with operator instructions on the GUI so that the operator can follow along with the steps. During the elution sequence, the GUI can be configured to provide warnings to the operator, or can prompt the operator to check various components or connections or can require a user to verify all components are properly connected by affirmatively checking or clicking “ok” on the GUI to allow the system to proceed to the next step, for example. In certain embodiments, if there is a leak, or likely to be a leak, the system can notify the operator via one or more means, such as audio and/or visual alarms from the HMI. When the system has completed the elution sequence, the system can notify the operator via one or more means, such as audio and/or visual alarms from the HMI and automatically restart the sequence when the next seed module is ready for elution, or wait for the operator to manually start the next sequence.

In accordance with at least one aspect of this disclosure, a non-transitory computer readable medium having computer executable instructions stored therein can be configured to cause a computer to execute a method, the method comprising controlling one or more valves of the system 100 to automatically switch the system between the Pb-212 production mode and the Pb-212 collection mode based at least in part on a predetermined operation sequence or based at least in part on user input and/or or based at least in part on one or more inputs received from one or more sensors included in the first flow path and/or the second flow path.

In embodiments of the system, the seed module 30 serves as the functional Pb-212 production unit in the system 100. In operation, the seed module 30 is configured to produce Pb-212 on a daily basis. In certain embodiments, the seed cartridge 10 can be or include a stainless steel or titanium housing 11 containing the radiation source 12 (e.g., Th-228 or Ra-224) adsorbed to a solid medium 13 in the support 14, such as titanium or a titanium compound. The seed cartridge housing 11 can include two fittings 15, 17 for connecting a conduit 19 (e.g., 1/16″ ID tubing) to the seed cartridge 10 for passing air over the support 14 in the production mode (i.e. when the seed cartridge is connected to the first flow path 42). The fittings 15 and 17 can be included in any suitable location on the housing 11, such as on a top or bottom of the housing (FIGS. 13A and 13B), or on a side of the housing 11, adjacent to the top and bottom, respectively (FIGS. 5A and 5B).

A goal of the novel cartridge 10 is to create a rigid, stable structure onto which the source 12 can be adsorbed. As discussed initially, most conventional techniques use quartz wool or chromatography beads, as the adsorption medium, however, quartz is not stable and difficult to work with and chromatography beads don't permit air transport. Moreover, quartz wool has a relatively low surface area of ≈5 m²/g.

Accordingly, embodiments of the novel cartridge 10 employ can employ a carbon graphite nanotubes (CGN) or can employ a titanium or titanium compound solid support, such as porous sintered foam 14, which are highly stable structures that provide a surface area of up to 1000 m²/g. In certain embodiments, it is also possible to create “filters” out of carbon nanotubes such that air flow is not interrupted. In certain embodiments, the a filter can be included in the seed cartridge 10 and can have a relatively large surface area but no resistance to air flow. Because of the high surface area, it is also possible to minimize the size of the cartridge 10.

In certain embodiments, the seed module 30 may be produced offsite and/or can be inserted into the field housing 300 offsite, and then provided to a lab who will then produce the Pb-212. In such embodiments, it is necessary to take certain precautions during shipping to avoid the escape of any Rn-220. For example, in certain embodiments, the seed module 20 can be fully assembled offsite by a supplier. In such cases, the seed cartridge 10 is already installed within the seed module housing 102, and to avoid escape of any Rn-220, the cartridge tubing 19 connected to the seed cartridge 10 can be and clamped with bulldog clamps, for example, or any other suitable means.

When the seed module 30 and/or the field housing 300 arrives at the lab, the lab only needs to install collection column 16 and tubing 19 and connect the valves of the collection assembly 40. Once the seed module 30 is installed, qualified, and functioning, it will keep generating Pb-212 without operator intervention until the source 12 needs to be replaced (e.g., about every 6-12 months for Th-228 or about every 3-5 days for Ra-224).

To begin operation of the system 100, the cartridge 10 is primed. To prepare or prime the seed cartridge 10, the empty cartridge undergoes a pressure test to confirm no leaks are present. Once confirmed, a Th-228 or Ra-224 solution is passed through the solid support 14 until the desired activity is adsorbed, then the support is washed extensively with water and dried to completion. In certain embodiments, the seed cartridge 10 preparation is performed offsite, by the supplier, rather than the lab. Once the primed seed cartridge 10 is a solid radiation source and is placed in the seed module 30 within the field housing, the valve 54 is placed in the first position, valves 51, 53 are opened, and the pump 46 is started.

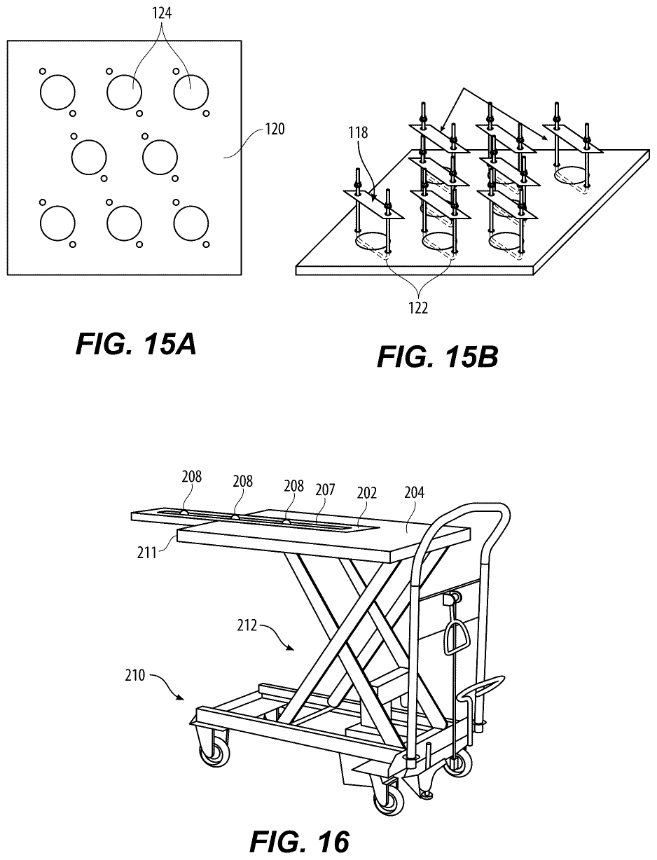

With reference now to FIGS. 15A to 18B, an exemplary embodiment of a thoron pump Kit is shown, one or more seed modules (e.g., a plurality of systems 100) can be included in a kit, shipped from a supplier to a lab. In certain embodiments, the kit can include eight seed modules 30 within a package (e.g., a crate). The package can include, as shown in FIG. 15A, a custom aluminum plate 120 disposed on or at the bottom of the crate. The top surface of the plate 120 can be milled out to hold the seed assemblies 20 but prevent rotation thereof. Mounting brackets 122 (e.g., stainless steel square U-bolts can be mounted from an underside of the plate 120 permit firm attachment of the seed assembly 20 to the crate plate using custom mounting plates 118 (e.g., ⅛″ thick aluminum rectangles with two holes drilled out, as shown in FIG. 15B). As shown in FIGS. 15A and 15B, the plate 120 has eight holes 124 for mounting eight seed assemblies 20, where each seed assembly 20 is secured with a respective mounting plate 118 and bracket 122. When mounting the seed modules 30, special care must be made to occlude the conduit 19, e.g., using bulldog clamps, as discussed above, to prevent leaking of Rn-220 during packaging and shipment. The package can further include a plurality of collection assemblies 40, which can be disconnected from the seed module 30 within the package.

When the package is received at a lab, for example, after removing mounting plates 118, a hook and chain or equivalent can be used to grab a respective handle and lift the module 30 onto a scissor lift table 200. An exemplary table 200 is shown in FIG. 16, for example. The exemplary table 200 is shown having been fitted with a steel extension plate 202 bolted to the top 204. The top extension 202 can be long enough to extend into a shielding and slide the seed assembly 20 onto a rotary turntable, which is described next. More specifically, the extension plate 202 is a longitudinal extension extending beyond a distal edge 211 of the tabletop to facilitate the insertion of the seed assembly 20 into the field housing 302. In certain embodiments, the table 200 can include a wide groove 207 defined in the extension plate 202 having one or more bearings 208 therein, to help guide linear movement of the seed assembly 20 off of the table 200. The table 200 further includes a wheeled base 210 and a height adjustable lift 212 connecting the wheeled base 210 to the tabletop 204.

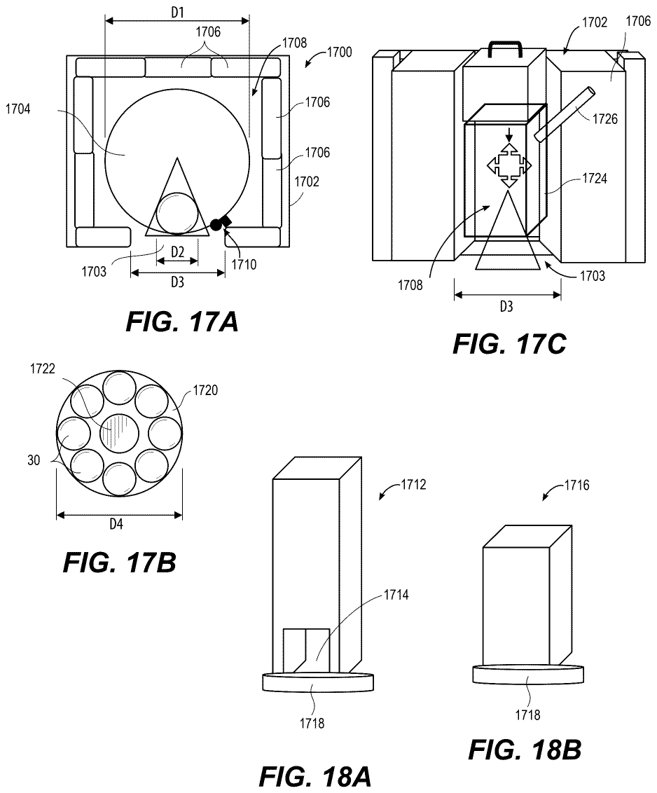

Referring now to FIGS. 17A-17C, an exemplary embodiment of a field 1700 is shown, the field 1700 including a field housing 1702 (a hot cell) and rotary table 1704. FIG. 17A shows a schematic plan view of the field housing 1702 with the rotary table 1704 therein. As best seen in FIG. 17A, the field housing 1702 includes a shielding element(s) 1706, such as lead or tungsten shield bricks. The field housing 1702 can be a thick hot cell (e.g., 2 or 2.5″) and can define an interior space 1708 (e.g., a vault), dedicated to a single Th-228 or Ra-224 field as shown in FIGS. 17A and 17B. “Field” as used herein refers to a plurality of seed modules 1930. The field housing 1702 defines a main opening 1703 for accessing the interior space 1708. Inside the rotary turntable 1704 is included inside the interior space 1708 of the field housing 1702 The turntable can include a stop 1710 at 359°. In certain embodiments, the turntable can be configured to hold more than one seed module 1930, for example the turntable 1704 can be configured to hold at least eight seed modules 1930 as shown in FIG. 17B. In the exemplary embodiment shown in FIGS. 17A-17C, the turntable 1704 can have a diameter D1 of about 18.5″, the seed module 1930 can have a diameter D2 of about 5″ to about 7″, and the main opening 1703 of the field housing 1702 can have a diameter D3 of about 12″. The handle of each respective seed module 1930 can be positioned parallel with the main opening 1703 so that all eight seed modules 1930 included in the kit can fit into the interior space 1708 on the turntable 1702. This is shown in FIG. 17B.

During operation of the system 1700, e.g., while the seed modules 1730 are producing Pb-212, the field housing 1702 will be closed completely for shielding purposes, however, in certain embodiments, the opening 1703 can be maintained to facilitate maintenance of the field 1700. In certain embodiments, when performing maintenance on the a collection assembly 1740, for example, the valves and pump, a lead plug 1712, 1716 can be inserted into the opening 1703 to shield at the level of the seed module 1730. The lead plug 1712, 17116 can be shaped according to which portions of the collection assembly 1740 need maintenance. For example, when working with the lower valves, the plug 1712 can be inserted, which has a cutout 1714. The cutout allows access to the lower valves, while providing a shield from the upper components. When servicing the upper components, the lead plug 1716 can be shorter than the plug 1712 so as to provide access to the upper valves and pumps, while shielding from the lower components. Exemplary lead plug shields are shown in FIGS. 18A and 18B. In certain embodiments, the lead plugs 1712, 1716 can be mounted to a movable mount 718, such as leg dolly or transfer bearings to facilitate sliding the plugs into and out of the field housing 1702.

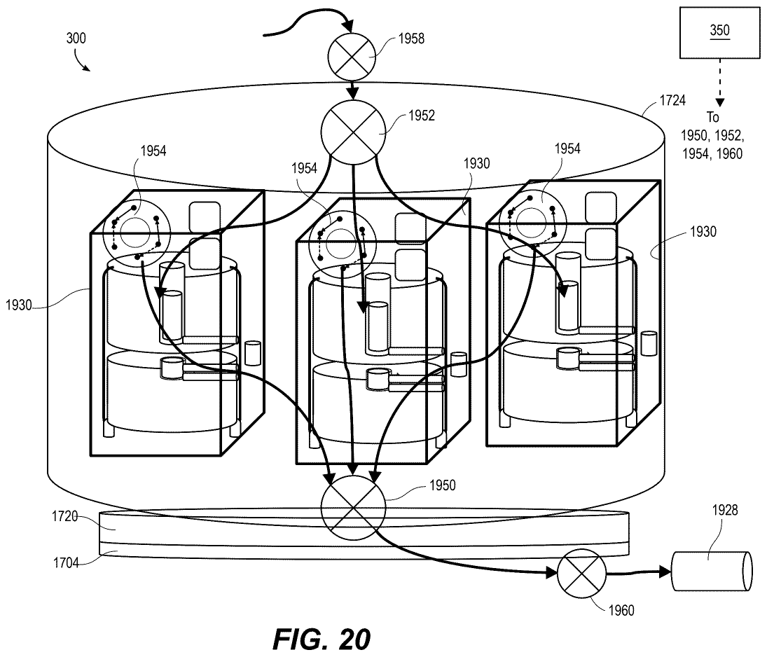

With specific reference to FIG. 17B, in certain embodiments, the field housing 702 can include a custom aluminum or steel base plate 720 with a central hole 1722 for mounting to the top of the rotary turntable 1704 to accept the respective seed modules 1930. The base plate 1720 can have a diameter D4 that matches the diameter D1 of the rotary turntable (e.g., about 18.5″). In certain embodiments, an aluminum frame 1724 can be included that attaches to the base plate 1720. This frame can be used to secure the top and bottom valves, permit rapid mounting of the switching valve/pump, and can play a role in creating the 359° stop required of the system. This is more clearly shown in FIG. 20, for example. In certain embodiments, the aluminum frame can be formed using additive manufacturing.

Though referencing FIG. 17C, in certain embodiments (e.g., any of the embodiments disclosed herein, including with respect to Field 300 described with respect to FIGS. 6-14B) a monitoring system can be included, the monitoring system having one or more imaging devices 1726 (e.g., cameras) configured to continuously capture the interior space 1708 of the field housing 1702. Since the field 1700 is closed during operation, it can become difficult to detect leaks or conditions where failures may be likely. Thus, the cameras 1726 can send images or video to a computer or user outside of the field housing 1702 to monitor for failures or potential failures. In certain embodiments, leak detection can be performed by the computer automatically (e.g., using artificial intelligence). In certain embodiments, the cameras can send the images or videos, alerts, or system status updates to the HMI and/or the GUI, i.e., the same GUI that provides output to the user regarding the status of the valves and plumbing

In certain embodiments, a colorimetric tape or paper that either bleeds or changes color in the setting of moisture can be included on one or more components of the seed module 1930 or the collection system 1740, e.g., the pump, so that small leaks can be detected quickly using the cameras within the field housing (e.g., as shown in FIG. 17C). Detecting leaks at the pump and upstream of the pump will help to avoid “catastrophic” disasters where liquid is passed to the seed cartridge. The imaging devices 1726 can be configured to continually monitor each component of the field 1700 to ensure no leaks occur, and issue alerts to the operator when a leak occurs, or when conditions indicate a potential leak is likely.

For example, in certain embodiments, the monitoring system continuously monitors the interior space 1708 of the field housing 1702 to detect malfunctions and/or conditions likely to cause malfunction, such as by detecting a change in the colorimetric tape or paper provided on one more component of each respective seed module. The controller and/or a processor (e.g., controller 350) can be configured to continuously review imaging data collected from the imaging device using one or more recognition techniques to recognize and detect malfunctions and/or conditions likely to cause malfunction and issue an alert to an operator indicating as much. The controller (e.g., controller 350) can include a memory configured to store the imaging data to generate a historical record of malfunctions. In certain embodiments, the controller 350 can be configured to perform data analytics on the historical record to improve efficiency and maintenance schedules for the system.

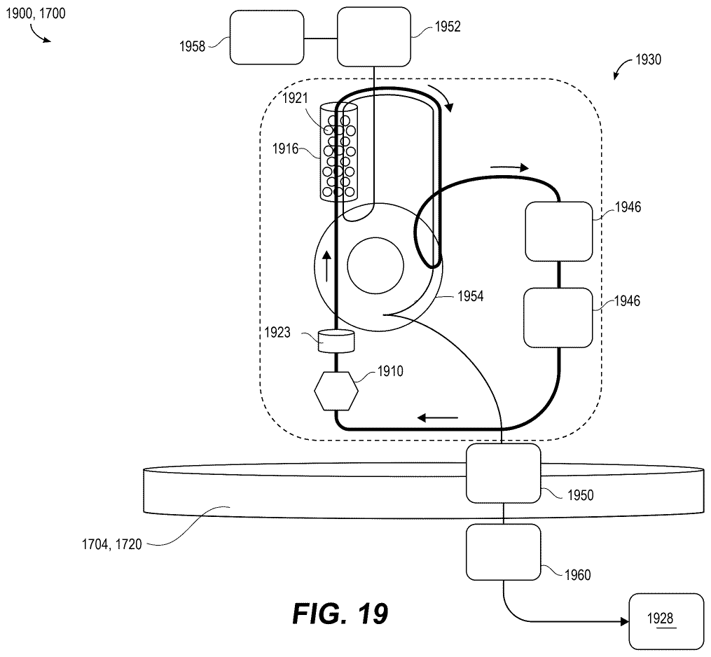

Turning now to FIGS. 19-21, the operation of the seed module 1930 within the field housing will be discussed. FIG. 19 shows the system 1900 where a single seed module 1930 is schematically represented on the rotary table 1704 and with the field housing 1702 removed for clarity and ease of explanation. In the first mode of operation, a production mode, the switching valve 1954 is placed in the first position. The pump 1946 operates to pump air through the radiation source 1912, and through the filter 1923, so that Rn-220 gas flows through the switching valve and into the collection column 1916, where the Rn-220 decays into Pb-212 on the collection beads 1921. The air is continually pumped through the closed loop of the first flow path 1942 until the switching valve 1954 is moved to the second position and the system is placed in collection mode.

In the collection mode, the switching valve 1954 moves to the second position to prevent the pump 1946 from passing air through to source 1912 and opens the open loop, the second flow path 1942. This allows the passing of eluent through the collection column 1916 to collect the adsorbed Pb-212. The collection mode includes a plurality of sequential elution steps, each step including a different fluid such as described in detail with respect to FIGS. 6-10.

In certain embodiments, the system 1900 can include an 8-way selector valve 1952 configured to act as a seed module selector valve, for selecting which seed module will be eluted at that time. The valve 1958 depicted in FIG. 19 can be an embodiment of the 5P valve 658 as discussed with reference to FIG. 6. In certain embodiments, the valve 1952 can be omitted and instead replaced with the second selector valve 654 and the 2P valve 656 and 3P valve 658 can be included as well, though not depicted in FIG. 19. The seed modules 1930 included in the field housing can be any one or more embodiment of a seed module 30 as described herein.

In certain exemplary embodiments, such as shown in FIG. 19, the elution steps include only four elution steps and a first four-way selector valve 1958 is positioned upstream of the collection column 1916 and a second four way selector valve 1960 is positioned downstream of the collection column 19116, the selector valves operating to switch between the elution steps.

Still with reference to FIG. 19, an exemplary embodiment of the switching valve 1954 is shown. Embodiments of the switching valve 1954 can include a 6-position (3 ports on each side) switching valve to prevent inadvertent washing of the seed cartridge 1910 when the system is operating in the collection mode. The switching valve 1954 can be configured to switch between the Rn-220 pumping mode (production mode) and a Pb-212 collection mode (collection or elution mode). In order to always isolate the liquid (elution) and air (thoron pump) modes of operation, the switching valve 1954 is configured such that “position 1” of the valve is one mode (e.g., Rn-220 pumping mode) and “position 2” is the other (e.g., Pb-212 collection mode). In FIG. 20, where a single switching valve 1954 is shown, the first flow path 1942 representing the pumping mode is shown in thick black lines, while the second flow path 1944 representing the collection mode is shown in thin black lines. In FIG. 19, the switching valve 1954 is set to position 1, production mode.

In certain embodiments, the 6-position selector valve 1954 is used over two independent 3-way valves because in this application, if one of the valves failed, then a state of mixed modes would occur, where liquid is pumped through tubing that should have had air. Accordingly, using a switching valve 1954 as presented herein prevents this from ever happening since if the 6-position valve fails, the entire system remains either in liquid or air mode, but not both.

In the exemplary embodiments, of FIG. 19, switching between the first and second modes is achieved by configuring the valve connections as shown in FIG. 19. As shown, the Rn-220 flows through the first flow path 1942 from the source 1912 to the filter 1923, through the valve 1954 to the collection column 1916, back to the switching valve 1954, to the pump 1946, into the dehumidifier cartridge 1948, and back to the seed cartridge 1910 in a closed loop. The second flow path 1944 defined is the elution pathway for collecting the Pb-212 collected in the collection column 1916. The second flow path 1944 begins at the inflow valve 1958, flows through an optional selector valve 1952, flows into the switching valve 1954, through the collection column 1916, back to the switching valve 1954, through a second optional selector valve 1954, and through an outflow valve 1960 to a downstream component. As shown in FIG. 19, the liquid/air inflow of the elution pathway never enters the pump and never enters any flow path leading to the seed cartridge 1910, maintaining the first flow path 1942 as a closed loop.

Downstream of the second outflow valve 1960 is an optional Pb-212 purification module 1928. While in certain embodiments the collection column 1916 can be the primary purification of Pb-212 (as there shouldn't be any Th-228 or Ra-224 contamination within the collection column, only the Rn-220 gas to Pb-212 solid conversion), to ensure the collected Pb-212 it is pure, high purity, or ultra-pure, additional purification methods can be put in place, such as module 1928.

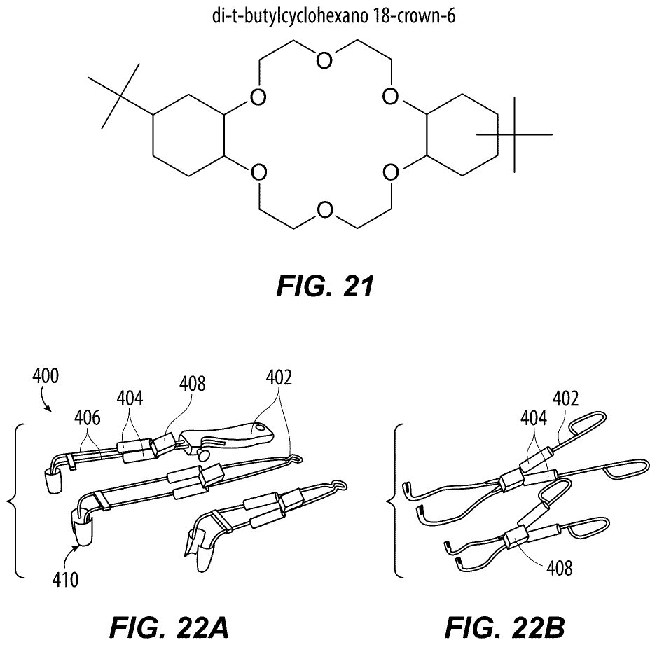

In certain embodiments, the purification module 1928 can utilize one or more Pb resins, an example of which is shown in FIG. 21. The exemplary resin shown in FIG. 21 has a lower weight % of extractant, reducing the k′ of metal ions, which is important for improving the recovery of Pb, as compared to an SR resin for example. Additionally, in certain embodiments, the module 328 and/or the Pb Resin uses an isodecanol diluent, while other SR resins use octanol. The total Pb capacity is ≈20 mg Pb/mL of resin and the functional capacity (loading before any significant breakthrough) is ≈10 mg Pb/mL of resin.

Since transport of the Pb-212 eluted from the collection column 16 will be directly through the conduit 1919 connecting the fields, there is no human exposure to the system, cleanliness is maintained, and there is minimal overall risk. However, to receive the Pb-212, embodiments can include a glass vial with a filtered venting needle in the receiving hot cell (field housing 1702). The transmission needle can be then replaced with an input needle to retrieve the purified Pb-212, which can then be used in manufacturing of the desired radiopharmaceuticals.

With specific reference now to FIGS. 19 and 20, exemplary embodiments of inflow and outflow valves will be describe with respect to an exemplary field 1700. Though the valves are described with respect to a field 1700 of 8 seed modules 1930, the concept can be applied to fields having more or less than 8 seed modules 190. The first inflow valve 1958 can be a 4-position selector valve, and the second inflow valve 1952 can be an 8-position selector valve. The number of positions of the second inflow valve can be selected to match the number of seed modules 1930 included in the field 1700. In the example shown in FIG. 20, 8 seed modules 1930 are included though only 3 are visible in the figure. The first inflow valve 1958 is positioned upstream of the second inflow valve 1952. The first inflow valve 1958 is configured to select the fluid that passes through each seed module, while the second inflow valve 1952 is configured to select which seed module 30 is receiving the fluid. The first and second inflow valves 1958, 1952 are only used in the second mode, i.e., the elution/collection mode. In certain embodiment, the eluent can be chosen as a function of the adsorbent material within the collection column and/or any secondary purifiers. In certain embodiments, the positions of the first valve can include, for example for a glass bead adsorbent:

| Position | Condition |
|---|---|
| 1 | Dead-end (no power condition) |
| 2 | 0.25M HCl glass bead elution |
| 3 | Water wash of glass beads |
| 4 | Nitrogen drying of glass beads |

The dead-end (no connection) position can be a default position when the valve loses power, which helps protect liquid flow when not wanted or needed. In certain embodiments, a 0.25 M HCl wash can be used to elute the Pb-212 adsorbed to the beads and flows it to the manufacturing hot cell. A dH₂O wash is included to remove HCl, which can damage tubing, fitting, and valves over time. This wash step is another way to achieve risk mitigation and a mean-time-between-failures (MTBF). The nitrogen flushing places the glass beads back in their starting state to adsorb Pb-212, and further helps prevent moisture from entering the seed cartridge.

The system 1900 further includes a first outflow valve 1960 and a second outflow valve 1950. The first outflow valve 1960 is another 4-position selector valve for providing the spent eluent to its respective discharge and the second outflow valve 1950 is another 8-position selector valve for discharging the eluent from a respective seed module 1930. The position of the first outflow valve 1960 should match the position of the first inflow valve 1958. The respective discharges can be or include a downstream Pb-212 collection container and container for recycling or disposal of spent eluent.

In certain embodiments, e.g., where eight seed modules 1930 are included on the rotary table 1704, the 8-position selector inflow valve 1958 is fixed to the frame 1724 while the 8-position selector outflow valve 1950 is mounted to the rotary table 1704 itself. This is shown in FIG. 20, for example. These 8-position selector valves, should be set identically since they determine which seed module 30 is being harvested for its Pb-212.

To summarize FIG. 20, which shows an exemplary set up with multiple seed modules 1930 on the rotary table 1704, each respective seed module 1930 will include a respective switching valve 1954 for switching between the two modes of operation. Each rotary table 1704 will include two 4-position selection valves, one at the inflow 1958 and one at the outflow 1960 to switch between the fluids during elution. Each rotary table 1704 will also include two 8-position selection valves, one at the inflow 1952 and one at the outflow 1950 to select which seed module 1930 is receiving the fluids during elution. As shown, the 8-position selection valve 1952 is downstream of the 4-position selection valve 1958 at the inflow, and the 8-position selection valve 1950 is upstream of the 4-position selection valve 1960 at the outflow.

In certain embodiments, control of the valves (e.g., any or more of or all of the valves in the system 100, 1900) can be performed automatically by the controller 350 in operative communication with the valves. The controller 350 can also be configured for monitoring capabilities (e.g., pressure, radiation, flow, etc.), and control the valves based thereon. Additionally, the controller 350 can be configured to record the data determined during monitoring, and record each action taken by the controller 350 to create a historical record of operation of the field 300, 1700, or multiple fields 300, 1700. In certain embodiments, the controller 350 can be configured to operate the field 300, 1700 (or plurality of fields) on a predetermined operation schedule. The operating schedule can be determined as a function of the size of the field 300, 1700, and the number of seed modules 30 included therein, for example. The schedule can be configured to switch between production and collection mode, elution mode, and purification mode (where purification can occur outside of the field) in the most efficient manner to optimize Pb-212 production.

In certain embodiments, the schedule can also be configured to keep track of the remaining life of the respective seed modules 30, 1930. If multiple fields 300, 1700 are in use, the schedule should keep track of all fields 300, 1700 in use. Thus, the controller 350 can be configured to alert the operator when one or more seed modules 30, 1930, or one or more fields 300, 1700, are nearing end of life, so that the operator can source new seed module(s) 30, 1930. This allows operators to source the replacement modules before the current modules deplete, so there is reduced downtime between disposal and replacement of the depleted seed modules 30, 1930. The controller 350 can be configured to track historical data to minimize downtime, but maximize yield from the replacement modules, for example by preventing the new modules from sitting, while waiting for removal and disposable of the depleted modules.

With reference now to FIGS. 22A and 22B, included within the kit, or provided separately, an exemplary embodiment of a grasping device 400 is shown. The device 400 can include tongs 402 with an integrated torque gauge(s) 404. Because of the high levels of radioactivity within the field 300, 1700, it is advised not to handle the Luer Lock connectors by hand. The alternative is to use gripping tongs. However, conventional gripping tongs do not provide feedback regarding how much force (e.g., torque when screwing a Luer Lock) is being applied to the Luer Lock. Creating a torque measurement device using grips is difficult, though, because when gripping an object there are high forces being applied to each arm, which are different from the torque needed to be measured in this scenario.

However, the device 400 overcomes these challenges by using two strain gauges 404, one on each arm 406 and taking the difference between them. At rest the strains are zero. When gripping an object tightly, the strains are high but are opposite in directions, so they cancel each other out, so the reading would be zero. When gripping an object such as the Luer Lock and then turning the tong 402, the strains on the arms become unequal and the magnitude of this unequalness is a measure of the torque. A small electronic circuit 408 can be included to perform the difference measurement and display the result as torque, after calibration of the device. The display can be in any suitable form, such as an alphanumeric display of the torque, a colored display based on application of correct or incorrect torque (e.g., green for torque proper torque or improper torque within a defined tolerance and red for improper torque, either too high or too low), or an audible or tactile output to the user to signify when the correct versus incorrect torque is applied.

In certain embodiments, the ends 410 of the tongs 402 can also be modified to conform to a Luer Lock or other specific components of the field 300, 1700 to provide a better grip. This greatly improves the safety of the novel system. The tongs 402 are configured to measure the force being applied to Luer Lock connections to ensure the correct force is being applied to avoid loss of Pb-212 or Rn-220 through leaks (caused by too little force applied to the Luer Locks) and cracks (caused by too much force applied to the Luer Locks). Ensuring that each fitting, or Luer Lock, is properly tightened will improve the overall collection of Pb-212 since losses will be minimized. If included in the kit, the kit can include a plurality of devices 400, including different sizes or configurations as needed for the particular application.

The systems and methods provided herein provide a means for continuous generation and collection of high purity Pb-212 (“farming”) for use in manufacturing radiotherapeutics or radiopharmaceuticals. The farm can include, any one or more embodiment of the system described herein, including a plurality of systems. In certain embodiments, the farm can further include one or more transport carts and one or more handling devices. In certain embodiments, each of the plurality of systems, the one or more transport carts, and the one or more handling devices can all be included in the kit. The farm can further include a Pb-212 purifier, and in certain embodiments, the Pb-212 purifier is or includes a Pb-212 resin. In certain embodiments, the farm can be started by assembling a plurality of kits as described herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

1. A system for the continuous production of Pb-212, comprising:
a first flow path, having disposed therein:
a radiation source configured to decay into gaseous Rn-220;
a collection column configured to collect the gaseous Rn-220 released from radiation source, the collection column packed with a medium configured to adsorb Pb-212 generated from decay of Rn-220 within the collection column; and
a pump configured to pump air through the first flow path to push the Rn-220 from the radiation source to the collection column; and
a second flow path, having disposed therein:
one or more inflow valves upstream of the collection column configured to flow one or more fluids through the collection column to elute the collection column thereby collecting the Pb-212;
the collection column; and
one or more outflow valves downstream of the collection column configured to pass the collected Pb-212 to a downstream component; and
a switching valve disposed in both the first flow path and the second flow path configured to selectively switch between a first mode of operation in which the first flow path is utilized and a second mode of operation in which the second flow path is utilized, and wherein the switching valve prevents simultaneous use of the first flow path and second flow path.

2. (canceled)

3. The system of claim 1, further comprising a source housing having an inlet and an outlet and an adsorbent included within the housing between the inlet and the outlet, configured to adsorb a parent isotope, and allow flow therethrough from the inlet to the outlet, wherein the adsorbent is or includes titanium, a titanium compound, a carbon graphite nanotube filter, a stainless-steel wool having a phosphate conversion coating, quartz wool, activated alumina, zeolites, or Metal-Organic Frameworks (MOFs).

4. The system of claim 1, wherein the parent isotope is Th-228 or Ra-224

5. The system of claim 1, wherein the medium packed within the collection column includes glass beads, metal beads or a metallic sintered foam packing, or a combination thereof.

6. The system of claim 1, further comprising a moisture trap disposed in the first flow path downstream of the pump configured to reduce or eliminate moisture within the first flow path to prevent washout of the source.

7. (canceled)

8. The system of claim 1, wherein:
the one or more inflow valves include a multi-position fluid selector inflow valve configured to sequentially pass a respective fluid of a plurality of fluids from a respective fluid source to the collection column based on a position of the multi-position fluid selector inflow valve; and
the one or more outflow valves includes a first multi-position outflow valve configured to pass one or more fluids of the plurality of fluids from the collection column to a first downstream component, a second downstream component, or to bypass the second downstream component based on a position of the first multi-position outflow valve, and a second multi-position outflow valve configured to pass one or more fluids of the plurality of fluids from the first muti-position outflow valve to a third downstream component or a fourth downstream component based on a position of the second multi-position outflow valve.

9. The system of claim 8, wherein the switching valve is a first switching valve, and wherein the one or more inflow valves further includes a second switching valve upstream of the first switching valve configured to selectively pass the respective fluid from the muti-position fluid selector inflow valve to the collection column or to bypass the collection column based on a position of the second switching valve.

10. The system of claim 9, wherein the second switching valve is a two-position switching valve configured to switch between a first position in which one or more respective fluids pass from the multi-position fluid selector inflow valve pass through the collection column and a second position in which the one or more respective fluids pass from the multi-position fluid selector inflow valve bypass the collection column.

11. The system of claim 10, wherein the multi-position fluid selector inflow valve is a six-position fluid selector valve configured to pass one or more of the plurality of fluids through the collection column based on a position of the six-position fluid selector inflow valve wherein each position of the multi-position fluid selector inflow valve is fluidically connected to a respective fluid source.

12. The system of claim 11, wherein the fluids include, water, ethanol, nitrogen, nitric acid, and sodium acetate.

13. The system of claim 11, wherein the first multi-position outflow valve is a two-position selector valve configured to pass one or more of the plurality of fluids from the collection column or the respective fluid source based on the position of the six-position fluid selector inflow valve, based on the position of the second switching valve, and based on the position of the first multi-position outflow valve, and wherein the first multi-position outflow valve is configured to pass the one or more fluids from the second switching valve to the second multi-position outflow valve or the second downstream component in a first position and to the first downstream component in a second position.

14. The system of claim 13, wherein the second multi-position outflow valve is a four-position selector valve configured to pass one or more of the plurality of fluids from the first multi-position outflow valve based on the position of the six-position fluid selector inflow valve, based on the position of the second switching valve, based on the position of the first multi-position outflow valve, and based on the position of the second multi-position outflow valve, and wherein the second multi-position outflow valve is configured to pass the one or more fluids from the second switching valve or the second downstream component to the third downstream component in a first position, to the fourth downstream component in a second position, and to the first downstream component in the third position.

15. The system of claim 1, wherein the first downstream component is a waste collector, the second downstream component is a secondary Pb-212 purifier, the third downstream component is a Pb-212 production hot cell, and the fourth downstream component is a dead end pressure channel.

16-17. (canceled)

18. The system of claim 1, further comprising the a seed cartridge included in a seed cartridge housing, the housing including a first coupler and a second coupler configured to connect the housing to the flow path, and further comprising a second seed cartridge having a second housing including a first coupler and a second coupler configured to connect the second housing to the flow path, wherein the second coupler of the first housing is configured to couple to the first coupler of the second housing, to fluidically connect the first seed cartridge to the second seed cartridge in series in the first flow path.

19. (canceled)

20. The system of claim 1, further comprising, a seed cartridge housing, the source included within the seed cartridge housing, and wherein the seed cartridge housing is housed within a field housing, wherein the at least a portion of the second flow path is housed outside of the field housing.

21. The system of claim 20, wherein the field housing defines an interior vault space surrounded by a shield.

22. (canceled)

23. The system of claim 21, further comprising a plurality of seed modules within the field housing, wherein
the one or more inflow valves includes a multi-position fluid selector inflow valve configured to sequentially pass a respective fluid of a plurality of fluids from a respective fluid source to the collection column based on a position of the multi-position fluid selector inflow valve; and
wherein the switching valve is a first switching valve, and wherein the one or more inflow valves further includes a second switching valve upstream of the first switching valve configured to selectively pass the respective fluid from the muti-position fluid selector inflow valve to the collection column or to bypass the collection column based on a position of the second switching valve,
wherein the multi-position fluid selector inflow valve is operatively connected to be supported outside of the vault space and outside of the field housing, and wherein a respective second switching valve is included for each respective seed module.

24. The system of claim 23, the one or more outflow valves includes a first multi-position outflow valve configured to pass one or more fluids of the plurality of fluids from the collection column to a first downstream component, a second downstream component, or to bypass the second downstream component based on a position of the first multi-position outflow valve, and a second multi-position outflow valve configured to pass one or more fluids of the plurality of fluids from the first muti-position outflow valve to a third downstream component of a fourth downstream component based on a position of the second multi-position outflow valve, wherein each seed module includes a respective first downstream component, second downstream component, and fourth downstream component within the field housing but outside of the seed module, and wherein the third downstream component is external to the respective seed module and external to the field housing.

25. The system of claim 20, further comprising a monitoring system disposed on or within the field housing configured to monitor operation of the seed module within the housing and configured to detect malfunctions and/or conditions likely to cause malfunction.

26-29. (canceled)

30. The system of claim 1, further comprising a controller is further configured to automatically control the switching valve to switch between the first mode and second mode of operation based on a predetermined switching schedule.

31. The system of claim 30, wherein the controller is configured to store operational data to generate a historical record of operation of one or more fields to track a life cycle of each respective seed module and respective source included therein, and wherein the controller is configured to perform data analytics on the historical record to develop a replacement schedule for each respective seed module and/or source to minimize downtime during removal, disposal, and replacement of a depleted source and a new source, maximizing Pb-212 yield over time and over the plurality of seed modules within the field or one or more fields.

32-49. (canceled)

50. A farm for continuous generation and collection of Pb-212 for use in manufacturing radiotherapeutics or radiopharmaceuticals, comprising:
a plurality of field housings having therein a plurality of systems as recited in claim 1, each system having its own radiation source, and each system fluidically connected to the second flow path to provide the Pb-212 collected in each system to a Pb-212 accumulator, wherein each field housing is in fluid communication with the Pb-212 accumulator or a respective Pb-212 accumulator,
wherein each system is configured to continuously and iteratively automatically switch between the Pb-212 collection mode and the Pb-212 elution mode without operator intervention until the source is depleted.

51-52. (canceled)

53. A method for continuous generation and collection of Pb-212 from a radiation source, comprising:
continuously pumping air through a first flow path to push gaseous Rn-220 generated from decay of the Th-228 or Ra-224 source to a collection column disposed in the first flow path downstream of the Th-228 or Ra-224 source until the collection column reaches a predetermined Pb-212 accumulation threshold;
automatically operating a switching valve to switch a mode of operation from a Pb-212 collection mode to a Pb-212 elution mode, wherein pumping air through the first flow path is stopped;
sequentially passing a sequence of fluids through a second flow path to elute the Pb-212 in the collection column, wash the collection column, and/or dry the collection column until the collection column is reset; and
automatically operating the switching valve to switch the mode of operation from the Pb-212 elution mode to the Pb-212 collection mode, wherein passing the sequence of fluids through the second flow path is stopped and pumping air through the first flow path is resumed.

54. (canceled)
